(19) United States
(12) Patent Application Publication
(10) Pub. No.: US 2018/0357484 A1
(43) Pub. Date: Dec. 13, 2018

(54) VIDEO PROCESSING DEVICE AND VIDEO PROCESSING METHOD

(71) Applicant: SONY CORPORATION, Tokyo (JP)

(72) Inventor: Makoto OMATA, Kanagawa (JP)

(73) Assignee: SONY CORPORATION, Tokyo (JP)

(21) Appl. No.: 15/779,165

(22) PCT Filed: Nov. 17, 2016
(86) PCT No.: PCT/JP2016/084032

§ 371 Date: May 25, 2018

(30) Foreign Application Priority Data
Feb. 2, 2016 (JP) 2016-017697

(51) Int. Cl. G06K 9/00

(52) U.S. Cl. CPC G06K 9/00718; G06K 9/00805; G06K 9/00825; G06K 9/00818; G06K 9/00798

(57) ABSTRACT

An object recognition unit subjects a video of surroundings of the vehicle and a video of the inside of the vehicle room to the object recognition, the videos having been obtained by the video obtaining unit, and detects, on the basis of the result of the recognizing, near miss characteristics related to a collision between objects, abnormal driving of an own vehicle, illegal driving of the own vehicle or surrounding vehicles, or the like. Basically, according to a detection signal of near miss characteristics output from the object recognition unit, the control unit controls trigger recording of a video of the in-vehicle camera obtained by the video obtaining unit.

### TECHNICAL FIELD

The technique disclosed in the present description relates to video processing device and method that control recording of a video and analyze a recorded video, and in particular to video processing device and method that control recording of a video captured by an in-vehicle camera and analyze a recorded video.

### BACKGROUND ART

The development of devices for recording vehicle information including a video captured by an in-vehicle camera is being pushed forward. This kind of devices is also called “drive recorder” or “event data recorder” (hereinafter unified as “drive recorder”). Information recorded in the drive recorder is important for objectively determining behavior of an automobile before and after an accident, and for aiming at accident prevention. Recently, many automobiles come to be equipped with drive recorders.

The primary purpose of a drive recorder is to record an accident. In a finite time period within which recording to a memory is allowed, it is necessary to save recording of an accident so as to prevent the recording from being overwritten while vehicle information detected every moment is overwritten and saved. There are many drive recorders that are each equipped with a function of detecting “a shock caused by collision” or “a change in acceleration caused by sudden braking resulting from a near miss and the like” on the basis of, for example, information from an acceleration sensor, and then saving a video including before and after the shock or the change in acceleration with the video brought into an overwrite protected state (refer to, for example, Patent Documents 1 and 2).

However, in a case where the information from the acceleration sensor is used, it is difficult to distinguish the change in acceleration caused by an accident or a near miss from a change in acceleration caused by, for example, a difference in level, or recesses and projections, of a road surface, or how a driver drives. As the result, overwrite protection caused by a false detection frequently occurs, and therefore an accident video and a near miss video are buried in many videos caused by false detections, which prevents the function of the drive recorder from being effectively used.

In addition, there is also a case where the information from the acceleration sensor is not capable of reacting to, for example, a collision with an object that is much lighter than the self weight of a vehicle, or a mischief during parking. There also exists a product that allows a user to individually adjust the sensitivity of a sensor on an installed vehicle basis.

However, there is also a case where a user cannot adjust the sensitivity of a sensor because adjustment for reducing the false detections requires much labor.

### CITATION LIST

### Patent Document

Patent Document 1: Japanese Patent Application Laid-Open No. 2012-221134
Patent Document 2: Japanese Patent Application Laid-Open No. 2013-182573

### SUMMARY OF THE INVENTION

### Problems to be Solved By the Invention

An object of the technique disclosed in the present description is to provide superior video processing device and method that are capable of recording only an accident video and a near miss video from videos captured by an in-vehicle camera, or capable of extracting an accident video and a near miss video from recorded videos of the in-vehicle camera.

### Solutions to Problems

The technique disclosed in the present description has been made in consideration of the above-described problems, and a first aspect thereof is a video processing device that includes:

an object recognition unit that, on the basis of a result of recognizing an object included in a video obtained by image-capturing an outside or an inside of a vehicle, detects characteristics of a scene in which there is a possibility of leading to an accident; and

a control unit that, according to detection of the characteristics, controls processing of the video.

According to a second aspect of the technique disclosed in the present description, the object recognition unit of the video processing device described as the first aspect is configured to detect, as the characteristics, characteristics related to an approach of an object recognized from the video.

According to a third aspect of the technique disclosed in the present description, the object recognition unit of the video processing device described as the first aspect is configured to detect, as the characteristics, characteristics related to approaches of surrounding vehicles to each other, the surrounding vehicles having been subjected to object recognition.

According to a fourth aspect of the technique disclosed in the present description, the object recognition unit of the video processing device described as the first aspect is configured to detect, as the characteristics, characteristics related to an approach of the vehicle to a surrounding vehicle subjected to object recognition or other objects.

According to a fifth aspect of the technique disclosed in the present description, the object recognition unit of the video processing device described as the second aspect is configured to detect characteristics related to the approach by further referring to a range image.

According to a sixth aspect of the technique disclosed in the present description, the video processing device described as the second aspect is further provided with a vehicle outside information detection part that detects a surrounding environment of the vehicle. In addition, the object recognition unit is configured to detect characteristics related to the approach further in consideration of the surrounding environment.

According to a seventh aspect of the technique disclosed in the present description, the object recognition unit of the video processing device described as the first aspect is configured to detect, as the characteristics, characteristics related to a spin or slip of the vehicle on the basis of a track, in a screen, of a road recognized from the video.

According to an eighth aspect of the technique disclosed in the present description, the object recognition unit of the video processing device described as the seventh aspect is configured to recognize, from the video, a road on the basis of a division line drawn on a road, a road shoulder, and a side strip.

According to a ninth aspect of the technique disclosed in the present description, the video processing device described as the first aspect further includes a vehicle state detection unit that detects a direction of a steering of the vehicle. In addition, the object recognition unit is configured to detect, as the characteristics, characteristics related to a spin or slip of the vehicle on the basis of an angle between a road recognized from the video and a direction of the steering.

According to a tenth aspect of the technique disclosed in the present description, the video processing device described as the seventh aspect is further provided with a vehicle outside information detection part that detects a surrounding environment of the vehicle. In addition, the object recognition unit is configured to detect characteristics related to a spin or slip of the vehicle in consideration of the surrounding environment.

According to an eleventh aspect of the technique disclosed in the present description, the object recognition unit of the video processing device described as the first aspect is configured to detect, as the characteristics, characteristics related to illegal driving of the vehicle or surrounding vehicles thereof, and a violative act of a pedestrian.

According to a twelfth aspect of the technique disclosed in the present description, the object recognition unit of the video processing device described as the eleventh aspect is configured to recognize a traffic lane or a side strip from the video, and to detect characteristics related to traveling that deviates from a traffic lane of the vehicle.

According to a thirteenth aspect of the technique disclosed in the present description, the object recognition unit of the video processing device described as the eleventh aspect is configured to recognize a traffic lane or a side strip and a surrounding vehicle from the video, and to detect characteristics related to traveling that deviates from a traffic lane of the surrounding vehicle.

According to a fourteenth aspect of the technique disclosed in the present description, the object recognition unit of the video processing device described as the eleventh aspect is configured to obtain information associated with regulations prescribed for a traveling road on the basis of a result of object recognition of the video, and when a travelling state of the vehicle or a surrounding vehicle thereof does not agree with the regulations, to detect characteristics related to illegal driving.

According to a fifteenth aspect of the technique disclosed in the present description, the video processing device described as the fourteenth aspect is configured to obtain information associated with regulations prescribed for a traveling road further on the basis of map information.

According to a sixteenth aspect of the technique disclosed in the present description, the object recognition unit of the video processing device described as the eleventh aspect is configured to recognize, from the video, at least one of a road traffic sign installed on the roadside, a road traffic sign drawn on a road surface, a stop line position drawn on a road, and a traffic light, and when at least one of violation of a road traffic sign, disregard of a stop line position, and disregard of a traffic light, of the vehicle or a surrounding vehicle thereof, is detected, to detect characteristics related to illegal driving.

According to a seventeenth aspect of the technique disclosed in the present description, the object recognition unit of the video processing device described as the eleventh aspect is configured to subject a stop line on a road to object recognition, and in a case where it is determined, from a relationship between a vehicle speed or acceleration of the vehicle or a surrounding vehicle thereof and a stop line position, that stopping is impossible, to detect characteristics related to illegal driving of stop position disregard.

According to an eighteenth aspect of the technique disclosed in the present description, the object recognition unit of the video processing device described as the eleventh aspect is configured to subject a red signal or yellow signal of a traffic light to object recognition, and in a case where it is determined, from a relationship between a vehicle speed or acceleration of the vehicle and a position of a traffic light subjected to the object recognition, that the stopping is impossible, to detect characteristics related to illegal driving of traffic light disregard.

According to a nineteenth aspect of the technique disclosed in the present description, the object recognition unit of the video processing device described as the eleventh aspect is configured to subject both a traveling state of a surrounding vehicle and lighting of a lamp to object recognition, and when the traveling state does not agree with the lighting of the lamp, to detect characteristics related to violation related to nonperformance of signaling of the surrounding vehicle.

In addition, a twentieth aspect of the technique disclosed in the present description is a video processing method including:

an object recognition step for, on the basis of a result of recognizing an object included in a video obtained by image-capturing an outside or an inside of a vehicle, detecting characteristics of a scene in which there is a possibility of leading to an accident; and

a control step for, according to detection of the characteristics, controlling processing of the video.

### Effects of the Invention

According to the technique disclosed in the present description, superior video processing device and method that are preferably capable of controlling recording of a video captured by an in-vehicle camera and capable of analyzing a recorded video can be provided.

It should be noted that the effects described in the present description are to be construed as merely illustrative, and therefore the effects of the present invention are not limited to those described in the present description. In addition, the present invention may produce further additional effects in addition to the effects described above.

Still other objects, features, and advantages of the technique disclosed in the present description will become apparent from the following detailed description based on the embodiments and accompanying drawings described below.

### BRIEF DESCRIPTION OF DRAWINGS

FIG. 1 is a drawing schematically illustrating a configuration example of a vehicle control system 2000 to which the technique disclosed in the present description can be applied.

FIG. 2 is a drawing illustrating, as an example, installation positions of an image capturing unit 2410 and a vehicle outside information detection part 2420.

FIG. 3 is a drawing schematically illustrating a functional configuration of a video processing device 300 that controls recording of a near miss video.

FIG. 4 is a flowchart illustrating a processing procedure for controlling trigger recording of a near miss video by the video processing device 300.

FIG. 5 is a diagram illustrating a functional configuration of a video processing device 500.

FIG. 6 is a drawing schematically illustrating a functional configuration for performing processing of extracting a near miss video by an external device 600.

FIG. 7 is a flowchart illustrating a processing procedure for extracting a near miss video by the external device 600.

FIG. 8 is a diagram illustrating a functional configuration of a video processing device 800.

### MODE FOR CARRYING OUT THE INVENTION

Embodiments of the technique disclosed in the present description will be described below in detail with reference to the drawings.

A. System Configuration

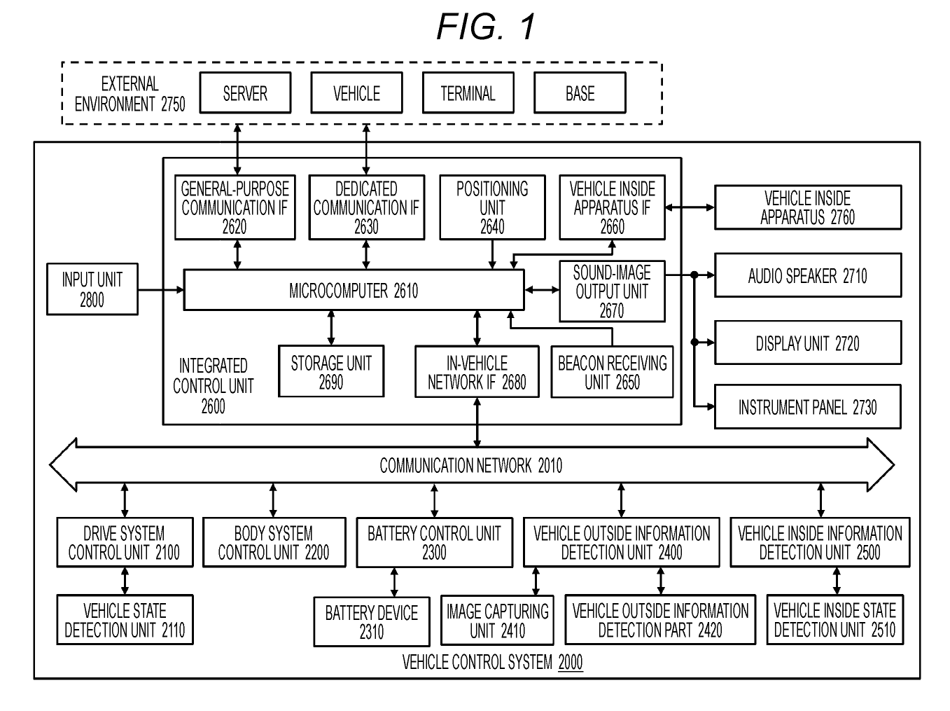

FIG. 1 schematically illustrates a configuration example of the vehicle control system 2000 to which the technique disclosed in the present description can be applied. The illustrated vehicle control system 2000 includes a plurality of control units including, for example, a drive system control unit 2100, a body system control unit 2200, a battery control unit 2300, a vehicle outside information detection unit 2400, a vehicle inside information detection unit 2500, and an integrated control unit 2600.

The control units 2100 to 2600 are interconnected to one another through a communication network 2010. The communication network 2010 may be, for example, an in-vehicle communication network in conformity with arbitrary communications standards such as Controller Area Network (CAN), Local Interconnect Network (LIN), Local Area Network (LAN), and FlexRay (registered trademark). In addition, the communication network 2010 may be a locally determined protocol.

The control units 2100 to 2600 are each provided with, for example: a microcomputer that performs computation processing according to various kinds of programs; a storage unit that stores a program executed by the microcomputer or parameters or the like used for various kinds of computations; and a driving circuit that drives various kinds of devices to be controlled. In addition, the control units 2100 to 2600 are each provided with a network interface (IF) used to perform communications with other control units through the communication network 2010, and a communication interface used to perform communications with devices, sensors, or the like inside and outside a vehicle by wire or wireless communication.

The drive system control unit 2100 controls the operation of a device related to a drive system of the vehicle according to various kinds of programs. For example, the drive system control unit 2100 functions as a control device for: a driving force generator that generates the driving force of the vehicle, such as an internal combustion engine and a driving motor; a driving force transmission mechanism for transferring the driving force to a wheel; a steering mechanism for adjusting a rudder angle of the vehicle; a braking device that generates the braking force of the vehicle; and the like. In addition, the drive system control unit 2100 may be provided with a function as a control device such as an Antilock Brake System (ABS) and an Electronic Stability Control (ESC).

A vehicle state detection unit 2110 is connected to the drive system control unit 2100. The vehicle state detection unit 2110 includes at least one of, for example, a gyro sensor that detects an angular speed of shaft rotary motion of a vehicle body, an acceleration sensor that detects acceleration of the vehicle, and a sensor for detecting the operation amount of an accelerator pedal, the operation amount of a brake pedal, an steering angle of a steering wheel, an engine rotational frequency, a rotational speed of a wheel, or the like. The drive system control unit 2100 performs computation processing by using a signal input from the vehicle state detection unit 2110, and controls an internal combustion engine, a driving motor, an electrically-driven power steering device, a brake device, and the like (all are not illustrated).

The body system control unit 2200 controls the operation of various kinds of devices provided in the vehicle body according to various kinds of programs. For example, the body system control unit 2200 functions as: a control device related to locking and unlocking of a door lock, and related to starting and stopping of the system 2000, the control device including a keyless entry system and a smart key system; and a control device for controlling a power window device or various kinds of lamps (including a head lamp, a back lamp, a brake lamp, a turn signal, and a fog lamp). When an electrical wave transmitted from a portable transmitter that is built into a key (or is substituted for the key) or a signal from various kinds of switches comes, the body system control unit 2200 controls a door lock device, a power window device, lamps, and the like (all are not illustrated) of the vehicle.

The battery control unit 2300 controls a secondary battery, which is an electric power supply source of the driving motor, according to various kinds of programs. For example, in the battery control unit 2300, a battery device 2310 equipped with the secondary battery measures a battery temperature and a battery output voltage of the secondary battery, the battery remaining capacity, and the like, and outputs the battery temperature, the battery output voltage, the battery remaining capacity, and the like to the battery control unit 2300. The battery control unit 2300 performs computation processing by using input information from the battery device 2310, and carries out the temperature adjustment control of the secondary battery, and the control of, for example, a cooling device (not illustrated) provided in the battery device 2310.

The vehicle outside information detection unit 2400 detects information of the outside of the vehicle equipped with the vehicle control system 2000. For example, at least one of the image capturing unit 2410 and the vehicle outside information detection part 2420 is connected to the vehicle outside information detection unit 2400.

The image capturing unit 2410 is what is called an in-vehicle camera. However, the image capturing unit 2410 includes at least one of a ToF (Time of Flight) camera, a stereo camera, a single-eyed camera, an infrared camera, and other cameras. The vehicle outside information detection part 2420 includes at least one of, for example, an environment sensor for detecting current weather or atmospheric phenomena, a surrounding information detecting sensor for detecting surrounding vehicles, obstacles, pedestrians and the like, and a sound sensor (a microphone that collects sounds generated around the vehicle) (all are not illustrated). In a case where the vehicle outside information detection part 2420 is a sound sensor, it is possible to obtain a sound outside the vehicle resulting from an accident or a near miss, the sound including a klaxon horn, a sudden braking sound, a collision sound, and the like.

The environment sensor mentioned here includes, for example, a raindrop sensor for detecting rainy weather, a fog sensor for detecting a fog, a sunshine sensor for detecting a degree of sunshine, and a snow sensor for detecting a snow fall. In addition, the surrounding information detecting sensor includes an ultrasonic sensor, a radar apparatus, and a Light Detection and Ranging, Laser Imaging Detection and Ranging (LIDAR) device.

The image capturing unit 2410 and the vehicle outside information detection part 2420 may be configured as sensors or devices that are independent of each other, or may be configured as a device in which a plurality of sensors or devices are integrated.

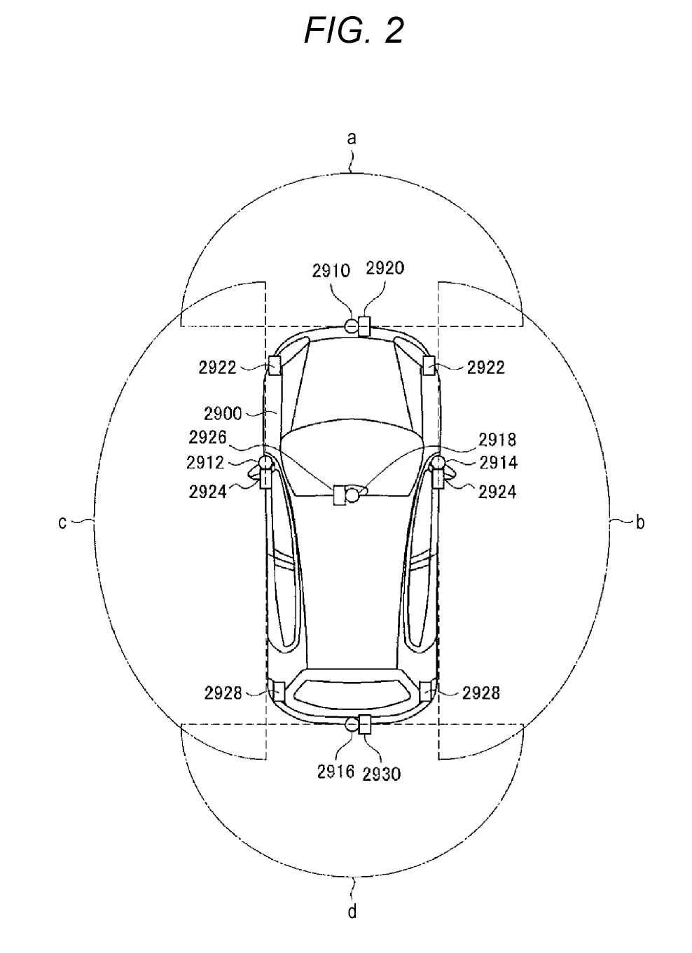

FIG. 2 illustrates, as an example, installation positions of the image capturing unit 2410 and the vehicle outside information detection part 2420. In the figure, image capturing units 2910, 2912, 2914, 2916, and 2918 correspond to the image capturing unit 2410. However, the image capturing unit 2410 is arranged at at least one position of, for example, the front nose, side-view mirrors, rear bumper and back door of the vehicle 2900, and an upper part of a windshield in a vehicle room. The image capturing unit 2910 provided at the front nose, and the image capturing unit 2918 provided at the upper part of the windshield in the vehicle room, mainly pick up an image viewed from the front of the vehicle 2900. On the basis of the image picked up from the front of the vehicle 2900, preceding vehicles, pedestrians, obstacles, traffic lights, traffic signs, traffic lanes, and the like can be detected. In addition, the image capturing units 2912 and 2914 provided at the side-view mirrors respectively mainly pick up images viewed from the sides of the vehicle 2900. Moreover, the image capturing unit 2916 provided at the rear bumper or the back door mainly picks up an image viewed from the back of the vehicle 2900.

In FIG. 2, an image capturing range a indicates an image capturing range of the image capturing unit 2910 provided at a front nose; image capturing ranges b and c indicate image capturing ranges of the image capturing unit 2912 and 2914 provided at left and right side-view mirrors respectively; and an image capturing range d indicates an image capturing range of the image capturing unit 2916 provided at the rear bumper or the back door. Superimposing image data captured by, for example, the image capturing units 2910, 2912, 2914, and 2916 enables a bird's-eye view image of the vehicle 2900 viewed from the upper part to be obtained. It should be noted that illustration of an image capturing range of the image capturing unit 2918 provided at the upper part of the windshield in the vehicle room is omitted.

The vehicle outside information detection parts 2920, 2922, 2924, 2926, 2928, and 2930 that are provided at the front, rear, sides, and corners of the vehicle 2900 and at the upper part of the windshield in the vehicle room respectively are configured by, for example, ultrasonic sensors or radar devices. The vehicle outside information detection parts 2920, 2926, and 2930 that are provided at the front nose, rear bumper, and back door of the vehicle 2900 and at the upper part of the windshield in the vehicle room may be, for example, LIDAR devices. These vehicle outside information detection parts 2920 to 2930 are mainly used to detect preceding vehicles, pedestrians, obstacles, or the like.

Referring to FIG. 1 again, the configuration of the vehicle control system 2000 will be continuously described. The vehicle outside information detection unit 2400 causes the image capturing unit 2410 to capture an image outside the vehicle (refer to FIG. 2), and receives captured image data from the image capturing unit 2410. In addition, the vehicle outside information detection unit 2400 receives detection information from the vehicle outside information detection part 2420. In a case where the vehicle outside information detection part 2420 is an ultrasonic sensor, a radar device, or a LIDAR device, the vehicle outside information detection unit 2400 emits an ultrasonic wave, an electromagnetic wave, or the like, and receives information of a reflected wave from the vehicle outside information detection part 2420.

On the basis of the information received from the vehicle outside information detection part 2420, the vehicle outside information detection unit 2400 may perform: image recognition processing that recognizes surrounding persons, vehicles, obstacles, signs or characters on a road surface, and the like; object recognition processing that detects or recognizes an object outside the vehicle; and distance detection processing that detects a distance to an object outside the vehicle. In addition, on the basis of the information received from the vehicle outside information detection part 2420, the vehicle outside information detection unit 2400 may perform environment recognition processing that recognizes surrounding environment, for example, a rain, a fog, or a state of a road surface.

Incidentally, the vehicle outside information detection unit 2400 may be configured to subject the image data received from the vehicle outside information detection part 2420 to distortion correction, position alignment, or the like, and to synthesize image data captured by a different image capturing unit 2410 so as to generate a bird's-eye view image or a panoramic image. In addition, the vehicle outside information detection unit 2400 may be configured to perform viewpoint conversion processing by using the image data captured by the different image capturing unit 2410.

The vehicle inside information detection unit 2500 detects information inside the vehicle. A vehicle inside state detection unit 2510 that detects, for example, a state of a driver who drives the vehicle (hereinafter merely referred to as “driver”) is connected to the vehicle inside information detection unit 2500. The vehicle inside information detection unit 2500 detects information inside the vehicle on the basis of driver state information input from the vehicle inside state detection unit 2510. For example, the vehicle inside information detection unit 2500 may calculate a fatigue degree or a concentration degree of the driver, and determines whether or not the driver is dozing. In addition, the vehicle inside information detection unit 2500 detects various driver states, and determines whether or not a driver (or a passenger other than the driver) is able to drive the vehicle (described later). It is assumed that the driver mentioned here indicates a passenger who sits on a driver seat inside the vehicle, or a passenger who is stored by the integrated control unit 2600 as a person who should drive the vehicle, among passengers inside the vehicle. The vehicle inside information detection unit 2500 may detect the driver on the basis of a position at which a passenger sits, or may determine the driver by comparing a face image registered as the driver beforehand with a captured face image on the basis of faces of passengers included in an image obtained by image-capturing the inside of the vehicle.

The vehicle inside state detection unit 2510 may include an in-vehicle camera (driver monitoring camera) that image-captures the inside of the vehicle room including the driver, the other passengers, and the like, a living-body sensor that detects biological information of the driver, and a microphone and the like that collects sounds inside the vehicle room. The vehicle inside information detection unit 2500 may be configured to subject a sound signal collected by the microphone to signal processing such as noise canceling. In addition, for the purpose of privacy protection or the like, the vehicle inside information detection unit 2500 may be configured to modulate only a specific sound. The living-body sensor is provided, for example, on a seat surface or a steering wheel, and detects a driver who grasps the steering wheel, and biological information of the driver who grasps the steering wheel. The microphone is capable of obtaining sounds inside the vehicle room resulting from an accident or a near miss, the sounds including a klaxon horn, a sudden braking sound, sounds (screams) of the passengers, and the like.

In addition, the vehicle inside state detection unit 2510 may include a load sensor that detects a load imposed on the driver seat and the other seats (whether or not a person sits on the seats). Moreover, the vehicle inside state detection unit 2510 may be configured to detect a state of the driver on the basis of the operation for various kinds of devices used when the driver operates the vehicle, the devices including an accelerator, a brake, a steering, a wiper, a turn signal, an air conditioner, other switches, and the like. Further, the vehicle inside state detection unit 2510 may be configured to check a status, the status including non-possession of a driver's license by the diver, and driver's refusal to drive.

The integrated control unit 2600 controls the overall operation in the vehicle control system 2000 according to various kinds of programs. In the example shown in FIG. 1, the integrated control unit 2600 is provided with a microcomputer 2610, a general-purpose communication interface 2620, a dedicated communication interface 2630, a positioning unit 2640, a beacon receiving unit 2650, a vehicle inside apparatus interface 2660, a sound-image output unit 2670, an in-vehicle network interface 2680, and a storage unit 2690. In addition, an input unit 2800 is connected to the integrated control unit 2600.

The input unit 2800 is configured by a device that allows a driver or the other passengers to perform input operation, the device including, for example, a touch panel, a button, a microphone, a switch, and a lever. The input unit 2800 may be, for example, a remote control device that uses infrared rays or other electrical waves, or an external connection apparatus that supports the operation of the vehicle control system 2000, the external connection apparatus including a portable telephone, a Personal Digital Assistant (PDA), a smart phone, a tablet (all are not illustrated), and the like. The input unit 2800 may use voice input by the microphone. The input unit 2800 may be, for example, a camera. In this case, a passenger is able to input information into the integrated control unit 2600 by a gesture. Moreover, the input unit 2800 may include, for example, an input control circuit that generates an input signal on the basis of information input by the passengers using the input unit 2800, and outputs the input signal to the integrated control unit 2600. By operating the input unit 2800, the passengers including the driver are allowed to input various kinds of data into the vehicle control system 2000, and to instruct the vehicle control system 2000 to perform processing operation.

The storage unit 2690 may include a Random Access Memory (RAM) that stores various kinds of programs executed by the microcomputer, and an Electrically Erasable and Programmable Read Only Memory (EEPROM) that stores various kinds of parameters, the computation result, detected values of sensors, and the like In addition, the storage unit 2690 may be configured by a large capacity storage (not illustrated) including: a magnetic storage device such as a Hard Disc Drive (HDD); a semiconductor storage device such as a Solid State Drive (SSD); an optical storage device; a magneto-optical storage device; and the like. The large capacity storage can be used for, for example, recording of a video of surroundings of the vehicle and a video of the inside of the vehicle room, the videos having been captured by the image capturing unit 2410 (constant recording, trigger recording of a near miss video (described later), etc.).

The general-purpose communication interface 2620 is a general-purpose communication interface that interfaces communications with various kinds of apparatuses existing in an external environment 2750. The general-purpose communication interface 2620 is provided with: a cellular communication protocol such as Global System of Mobile communications (GSM) (registered trademark), WiMAX, and Long Term Evolution (LTE) (or LTE-A (LTE-Advanced)); a wireless LAN such as Wi-Fi (registered trademark); and other wireless communication protocols such as Bluetooth (registered trademark). The general-purpose communication interface 2620 can be connected to an apparatus (for example, an application server, a control server, a management server (described later), or the like) that exists in an external network (for example, the Internet, a cloud network, or a company specific network) through, for example, a base station in cellular communications or an access point in a wireless LAN. In addition, the general-purpose communication interface 2620 may be connected to a terminal that exists in proximity to the vehicle (for example, an information terminal carried by a driver or a pedestrian, a shop terminal installed in a shop adjacent to a road along which the vehicle travels, a Machine Type Communication (MTC) terminal that is connected to a communication network without the intervention of a person (a home-use gas meter, an automatic selling machine, etc.) etc.) by using, for example, Peer To Peer (P2P) technique.

The dedicated communication interface 2630 is a communication interface that supports a communication protocol developed for the purpose of using for vehicles. The dedicated communication interface 2630 may be provided with standard protocols, for example, Wireless Access in Vehicle Environment (WAVE) that is a combination of IEEE802.11p that is a lower level layer and IEEE1609 that is an upper level layer, Dedicated Short Range Communications (DSRC), or a cellular communication protocol. Typically, the dedicated communication interface 2630 carries out V2X communication that is a concept including one or more of Vehicle to Vehicle communication, Vehicle to Infrastructure communication, Vehicle to Home communication, and Vehicle to Pedestrian communication.

The positioning unit 2640 receives, for example, a GNSS signal from a Global Navigation Satellite System

(GNSS) satellite (for example, a GPS signal from a Global Positioning System (GPS) satellite) to execute positioning, and generates position information that includes latitude, longitude, and altitude of the vehicle. Incidentally, the positioning unit 2640 may identify a current position on the basis of electric measurement information from a wireless access point by using PlaceEngine (registered trademark) and the like, or may obtain position information from a mobile terminal having a positioning function carried by a passenger, the mobile terminal being a portable telephone, a Personal Handy-phone System (PHS), or a smart phone.

The beacon receiving unit 2650 receives an electrical wave or an electromagnetic wave transmitted from, for example, a wireless station or the like installed on the road, and obtains a current position of the vehicle and road traffic information (information including traffic congestion, suspension of traffic, the time required, and the like). It should be noted that the function of the beacon receiving unit 2650 can also be provided with the function included in the above-described dedicated communication interface 2630.

The vehicle inside apparatus interface 2660 is a communication interface that handles connections between various kinds of apparatuses 2760 existing in the microcomputer 2610 and inside the vehicle. The vehicle inside apparatus interface 2660 may establish a wireless connection by using a wireless communication protocol that is, for example, a wireless LAN, Bluetooth (registered trademark), Near Field Communication (NFC), or Wireless Universal Serial Bus (USB) (WUSB). In addition, the vehicle inside apparatus interface 2660 may establish a cable connection such as USB, High Definition Multimedia Interface (HDMI) (registered trademark) and Mobile High-definition Link (MHL) through an unillustrated connection terminal (and a cable if necessary). The vehicle inside apparatus interface 2660 exchanges a control signal or a data signal with, for example, a mobile apparatus or a wearable apparatus possessed by a passenger, or the vehicle inside apparatus 2760 that is carried into the vehicle or is mounted thereto

The in-vehicle network interface 2680 is an interface that interfaces communications between the microcomputer 2610 and the communication network 2010. The in-vehicle network interface 2680 transmits and receives a signal or the like according to a predetermined protocol supported by the communication network 2010.

The microcomputer 2610 of the integrated control unit 2600 controls the vehicle control system 2000 according to various kinds of programs on the basis of information obtained through at least one of the general-purpose communication interface 2620, the dedicated communication interface 2630, the positioning unit 2640, the beacon receiving unit 2650, the vehicle inside apparatus interface 2660, and the in-vehicle network interface 2680.

For example, the microcomputer 2610 may calculate a control target value of the driving force generator, the steering mechanism, or the braking device on the basis of obtained information of the inside and outside of the vehicle, and output a control instruction to the drive system control unit 2100. For example, the microcomputer 2610 may be configured to perform cooperative control for the purpose of collision avoidance or shock mitigation of the vehicle, follow-up traveling based on a distance between vehicles, vehicle-speed maintaining traveling, automated driving, or the like.

In addition, the microcomputer 2610 may be configured to generate local map information that includes surrounding information at a current position of the vehicle on the basis of information obtained through at least one of the general-purpose communication interface 2620, the dedicated communication interface 2630, the positioning unit 2640, the beacon receiving unit 2650, the vehicle inside apparatus interface 2660, and the in-vehicle network interface 2680. In addition, the microcomputer 2610 may be configured to predict a risk on the basis of obtained information, the risk including, for example, a collision of the vehicle, an approaching pedestrian, building, or the like, and entering a closed road, and then to generate a warning signal. The warning signal mentioned here is, for example, a signal for causing an alarm sound to be produced or for causing a warning lamp to light up.

In addition, the microcomputer 2610 may be configured to realize a drive recorder function by using the storage unit 2690 described above and the like. More specifically, the microcomputer 2610 may be configured to control recording of a video of surroundings of the vehicle and a video of the inside of the vehicle room, the videos having been captured by the image capturing unit 2410 (constant recording, trigger recording of a near miss video (described later), etc.).

The sound-image output unit 2670 transmits at least one of a sound output signal and an image output signal to an output device that is capable of visually or audibly notifying passengers of the vehicle or persons outside the vehicle of information. In a case where the output device is a display device, the display device visually displays the result obtained by various kinds of processing performed by the microcomputer 2610, or information received from other control units, in various formats such as a text, an image, a table and a graph. In addition, in a case where the output device is an audio output device, the audio output device converts an audio signal that includes reproduced audio data, acoustic data, or the like into an analog signal, and then audibly outputs the analog signal. In the example shown in FIG. 1, an audio speaker 2710, a display unit 2720, and an instrument panel 2730 are provided as output devices.

The display unit 2720 may include at least one of, for example, an on-board display and a head-up display. The head-up display is a device that projects an image in a visual field of the driver by using the windshield (so as to be imaged at an infinite distance point). The display unit 2720 may be provided with an Augmented Reality (AR) display function. Other than the devices described above, the vehicle may be provided with a head phone, a projector, a lamp, or the like as an output device.

In addition, the instrument panel 2730 is arranged in front of the driver seat (and a passenger seat), and includes: a meter panel that indicates information required for traveling of an automobile, the meter panel including a speedometer, a tachometer, a fuel meter, a water temperature meter, and a distance meter; and a navigation system that performs traveling guide to a destination.

It should be noted that at least two control units among the plurality of control units that constitute the vehicle control system 2000 shown in FIG. 1 may be physically unified as one unit. In addition, the vehicle control system 2000 may be further provided with a control unit other than those shown in FIG. 1. Alternatively, at least one of the control units 2100 to 2600 may be physically configured by a group of two or more units. In addition, a part of functions that should be taken charge of by the control units 2100 to 2600 may be realized by other control units. In short, if the above-described computation processing realized by transmitting/receiving information through the communication network 2010 is configured to be performed by any of the control units, a change of the configuration of the vehicle control system 2000 is allowed. Moreover, a sensor, a device, or the like connected to any of the control units may be connected to other control units, and information detected or obtained by a certain sensor or device may be mutually transmitted/received between a plurality of control units through the communication network 2010.

B. Recording of Near Miss Video

In the vehicle control system 2000 according to the present embodiment, for example, the microcomputer 2610 is capable of realizing a drive recorder function by using the storage unit 2690 (or other large capacity storages).

Information recorded in the drive recorder is important for objectively determining behavior of an automobile before and after an accident, and for aiming at accident prevention. In other words, the primary purpose of the drive recorder is to record an accident video and a near miss video (hereinafter both videos are collectively called “near miss video”). Therefore, in a finite time period during which a video can be recorded in the storage unit 2690 or the like, it is necessary to correctly extract and record a near miss video while vehicle information detected every moment is constantly recorded (overwritten and saved in the finite time period).

Recording of a near miss video in response to detecting an event of an accident or a near miss is called “trigger recording”. The trigger recording includes, for example, a method in which in response to detecting an event of an accident or a near miss, a near miss video is recorded in a storage device used exclusively for trigger recording (or a storage area used exclusively for trigger recording) provided separately from constant recording, and a method in which an overwrite protection section of a near miss video is specified for a storage device that performs constant recording.

Many of drive recorders in the prior art detect an event of an accident or a near miss on the basis of information from an acceleration sensor. However, in a case where the information from the acceleration sensor is used, it is difficult to distinguish the change in acceleration caused by an accident or a near miss from a change in acceleration caused by, for example, a difference in level, or recesses and projections, of a road surface, or how a driver drives. In addition, there is also a case where the information from the acceleration sensor is not capable of reacting to, for example, a collision with an object that is much lighter than the self weight of a vehicle, or a mischief during parking. As the result, there exists a problem that false detection frequently occurs by trigger recording, and consequently a near miss video is buried in many videos caused by the false detections.

Accordingly, the present description discloses a technique in which trigger recording of a near miss video is performed with higher accuracy according to near miss characteristics that are detected on the basis of the result of recognizing an object included in a video captured by the in-vehicle camera.

According to the technique disclosed in the present description, the occurrence of a near miss is detected according to near miss characteristics based on the result of recognizing an object in a video captured by the in-vehicle camera. Therefore, false detection of an event of a near miss does not occur from a change in acceleration caused by, for example, a difference in level, or recesses and projections, of a road surface, or how a driver drives, which enhances the accuracy of trigger recording. In other words, recording of videos caused by false detections can be suppressed, and therefore a labor for searching and managing near miss videos can be largely reduced. Effects of the technique disclosed in the present description depend on the recent improvement in recognition technique for videos captured by in-vehicle cameras.

In addition, according to the technique disclosed in the present description, a near miss event in which a change in acceleration is small can also be detected on the basis of the result of recognizing an object in a video captured by the in-vehicle camera, the event including a collision with an object that is much lighter than the self weight of the vehicle, a mischief done during parking, and the like.

According to the technique disclosed in the present description, an event of a near miss is detected on the basis of the result of recognizing an object that appears in a video. Therefore, other than performing trigger recording as real time processing on the vehicle, even if processing is performed later on a device outside the vehicle, such as a Personal Computer (PC) and a server, after driving of the automobile ends, trigger recording can be performed. As a matter of course, high-accuracy trigger recording can also be performed for a recorded video of a drive recorder that has already been operated.

The technique disclosed in the present description is based on detecting an event of a near miss on the basis of the result of recognizing an object in a video captured by the in-vehicle camera. However, a near miss can be detected with higher accuracy by combining with a range image (depth map). For example, the range image can be obtained by using a stereo camera as the image capturing unit 2410.

In addition, the technique disclosed in the present description enables trigger recording of a near miss video to be performed with higher accuracy by combining near miss characteristics detected on the basis of the result of recognizing an object in a video captured by the in-vehicle camera with map information (a current position of the vehicle).

Moreover, the technique disclosed in the present description enables trigger recording of a near miss video to be performed with higher accuracy by combining near miss characteristics detected on the basis of the result of recognizing an object in a video captured by the in-vehicle camera with detection information detected by an acceleration sensor and other various sensors.

In the technique disclosed in the present description, near miss characteristics may be detected on the basis of the result of recognizing an object included not only in a video of surroundings of the vehicle (that is to say, the outside of the vehicle) captured by the image capturing unit 2410, but also in a video of the driver monitoring camera that captures the inside of the vehicle room.

B-1. Near Miss Characteristics

Here, a near miss that is a target of trigger recording will be considered.

The near miss can be roughly classified into three kinds: a near miss caused by driving of an own vehicle; a near miss caused by driving of surrounding vehicles; and a near miss caused by other than driving of the vehicles.

As causes of the near miss caused by driving of the own vehicle, abnormal driving of the own vehicle, and illegal driving of the own vehicle can be mentioned.

The abnormal driving of the own vehicle includes, for example, a spin and a slip of the own vehicle. When driving of the own vehicle becomes abnormal, a forward or backward road captured by the in-vehicle cameras such as the image capturing unit 2410 shows an abnormal track in a screen. Therefore, abnormal driving of the own vehicle can be detected by subjecting a road to object recognition from the video captured by the in-vehicle camera. For example, the road can be subjected to the object recognition by extracting, for example, a roadway center line, a traffic lane dividing line, and a division line such as a traffic lane dividing line, from a road image-captured by the in-vehicle camera. In addition, when the own vehicle has spun, a direction of steering becomes abnormal with respect to a traffic lane. Therefore, using a steering angle of a steering wheel, which has been detected by the vehicle state detection unit 2110, together with the result of recognizing an object on the road enables to detect an abnormality with higher accuracy.

Moreover, there is also a case where driving operation for avoiding a collision performed by the driver, such as sudden braking and abrupt steering, causes abnormal driving of the own vehicle such as a spin and a slip. In such a case, abnormal driving of the own vehicle can be detected by recognizing an object other than the own vehicle (a surrounding vehicle, a pedestrian, an animal, roadwork, a guard rail, a utility pole, a building, or other obstacles) from a video of surroundings of the own vehicle captured by the in-vehicle camera. When the own vehicle turns right or left, a blind spot is easily produced. An object existing at a blind spot position can also be recognized from a video of surroundings of the own vehicle captured by the in-vehicle camera.

There is also a case where abnormal driving of the own vehicle such as a spin and a slip occurs originating from a surrounding environment that includes the weather such as snow and rain, and a state of a road such as freezing of a road surface. Abnormal driving of the own vehicle caused by the deterioration of the surrounding environment can be detected quickly or beforehand by subjecting snow fall, rain, and a road surface to object recognition from a video of surroundings of the own vehicle captured by the in-vehicle camera.

Further, there is also a case where a state (abnormal behavior) of the driver such as inattentive or rambling driving, absence of the driver (including releasing of a handle for a long time), dozing while driving, and loss of consciousness may cause abnormal driving of the own vehicle. In such a case, abnormal driving of the own vehicle can be detected by using not only the recognition of an object in a video of the outside of the vehicle (surroundings of the own vehicle) captured by the image capturing unit 2410, but also the result of detecting a driver state by the vehicle inside state detection unit 2510 such as the driver monitoring camera and the living-body sensor. In addition, not only the video captured outside the vehicle by the image capturing unit 2410, but also the video captured inside the vehicle room by the driver monitoring camera, may be subjected to trigger recording.

In addition, there is a possibility that illegal driving of the own vehicle will subsequently result in an accident or a near miss. As illegal driving of the own vehicle, driving that violates the road traffic regulation by the own vehicle can be mentioned, the illegal driving including traveling that deviates from a traffic lane of the own vehicle, speed limit violation, disregard of a stop line, disregard of a traffic light, violation of one way traffic, other sign violations, and the like. The traffic regulation mentioned here is, for example, Road Traffic Law. Moreover, other than the violation of the traffic regulation, the violation may include an action against traffic rules and manners (the same applies hereinafter).

A division line drawn on a road (a roadway center line, a traffic lane dividing line, a roadway outside line, etc.), a pedestrian crossing, a side strip, a traffic light, and the like are subjected to object recognition from the video captured by the in-vehicle camera, and a regulation (including one way traffic, etc.) applied to a traveling road is identified from the result of object recognition of various road traffic signs that are placed on the roadside or drawn on road surfaces. Therefore, when driving of the own vehicle does not observe traffic rules, Illegal driving can be detected. In addition, if necessary, by using map information (at a current position of the own vehicle), information including, for example, traffic rules prescribed for a traveling road, such as speed limit and one way traffic, may be obtained.

A spin or a slip of the own vehicle causes a change in acceleration of the vehicle body. In addition, abnormal driving of the own vehicle is mostly accompanied by a change in acceleration of the vehicle body, resulting from the driving operation of sudden braking, abrupt steering, or the like. Therefore, even if the result of detection by the acceleration sensor is used, abnormal driving of the own vehicle can be detected. However, abnormal driving is not always accompanied by a change in acceleration. Further, a change in acceleration does not always result from abnormal driving. Meanwhile, in the case of illegal driving of the own vehicle, when the driver overlooks traffic rules prescribed for a traveling road, for example, when the driver overlooks a road traffic sign, the driving operation of sudden braking, abrupt steering, or the like is not performed. Accordingly, to begin with, it is difficult to detect illegal driving on the basis of the detection result of the acceleration sensor. In contrast to this, according to the technique disclosed in the present description, not only abnormal driving but also illegal driving of the own vehicle can be preferably detected on the basis of the result of recognizing an object in a video captured by the in-vehicle camera.

As causes of the near miss caused by driving of surrounding vehicles, abnormal driving of a surrounding vehicle, and Illegal driving of a surrounding vehicle can be mentioned.

The abnormal driving of surrounding vehicles includes: approaches of surrounding vehicles (above all, preceding vehicles) to each other; an approach of a surrounding vehicle to the own vehicle; and the like. Approaches of surrounding vehicles to each other, and an approach of a surrounding vehicle to the own vehicle, can be detected by subjecting surrounding vehicles to object recognition from the video captured by the in-vehicle camera. Moreover, a distance between surrounding vehicles, and a distance between the own vehicle and a surrounding vehicle can be measured with higher accuracy by using a range image in combination.

In addition, there is a possibility that illegal driving of a surrounding vehicle will involve the own vehicle, resulting in an accident or a near miss. As illegal driving of a surrounding vehicle, traveling that deviates from a traffic lane of the surrounding vehicle, speed limit violation, disregard of a stop line, disregard of a traffic light, violation of one way traffic, and other sign violations can be mentioned. A division line drawn on a road (a roadway center line, a traffic lane dividing line, a roadway outside line, etc.), a side strip, and the like are subjected to object recognition from the video captured by the in-vehicle camera, and a regulation (including one way traffic, etc.) applied to a traveling road is identified from the result of object recognition of various road traffic signs that are placed on the roadside or drawn on road surfaces (same as above). If necessary, information including, for example, traffic rules may be obtained by using map information (at a current position of the own vehicle). In addition, when a surrounding vehicle, an object of which has been recognized on the basis of the video captured by the in-vehicle camera, does not observe traffic rules, Illegal driving can be detected.

In a case where the own vehicle is exposed to danger, for example, in a case where a surrounding vehicle that performs abnormal driving or illegal driving is approaching to the own vehicle, driving operation of sudden braking, abrupt steering, or the like by the drive is accompanied by a change in acceleration. Therefore, even if the result of detection by the acceleration sensor is used, a near miss can be detected. However, when a surrounding vehicle that performs abnormal driving or illegal driving exits in a blind spot of the driver, with the result that the driver has overlooked the surrounding vehicle, the driving operation of sudden braking, abrupt steering, or the like is not performed. Therefore, it is difficult to detect a near miss on the basis of the detection result of the acceleration sensor. In addition, the driver often does not notice illegal driving of a surrounding vehicle. In contrast to this, according to the technique disclosed in the present description, abnormal driving or illegal driving of not only the own vehicle but also a surrounding vehicle can be preferably detected on the basis of the result of object recognition of a video captured by the in-vehicle camera. Additionally, even if abnormal driving or illegal driving of the surrounding vehicle does not lead to a near miss or an accident of the own vehicle, the abnormal driving or the illegal driving may subsequently cause an accident of surrounding vehicles. Therefore, the video of abnormal driving or illegal driving of the surrounding vehicle is worth performing trigger recording.

Incidentally, Patent Document 1 discloses a driving assistance device that controls starting of recording to a drive recorder on the basis of the result of recognizing an image of an external video. However, the driving assistance device merely recognizes lighting of a stop lamp, a hazard lamp, and a turn signal of a preceding vehicle. In other words, according to the technique disclosed in Patent Document 1, recording of a video is controlled on the basis of a rough behavior of a preceding vehicle, and therefore there is a high possibility that a video other than the abnormal driving of the preceding vehicle (that is to say, a video that is not a near miss) will be recorded by mistake. In addition, in the technology described in Patent Document 1, it is considered that a near miss video related to abnormal driving of a surrounding vehicle other than the preceding vehicle, and related to illegal driving of a surrounding vehicle, cannot be recorded.

As causes of a near miss caused by other than driving of vehicles (the own vehicle and surrounding vehicles), a surrounding environment including the weather such as snow and rain, a state of a road such as freezing of a road surface, and existence of obstacle objects other than vehicles (a surrounding vehicle, a pedestrian, an animal, roadwork, a guard rail, a utility pole, building, and other obstacles) can be mentioned. A cause of a near miss other than driving of vehicles can be detected by performing object recognition of a surrounding environment including a snow fall and a rain, a road surface, surrounding objects, and the like from a video of surroundings of the own vehicle captured by the in-vehicle camera.

The occurrence of a spin or a slip of the own vehicle under the influence of the weather and a state of a road surface is accompanied by a change in acceleration of the vehicle body. Therefore, even if the result of detection by the acceleration sensor is used, the occurrence of a spin or a slip of the own vehicle can be detected. In addition, when an object approaches the own vehicle, the driving operation of sudden braking, abrupt steering, or the like by the driver is accompanied by a change in acceleration. Therefore, even if the result of detection by the acceleration sensor is used, the driving operation of sudden braking, abrupt steering, or the like can be detected. However, even when the surrounding environment is a very bad or unfavorable state, a spin or a slip of the vehicle has not occurred yet. Therefore, if the driver does not carry out the driving operation of sudden braking, abrupt steering, or the like, it is difficult to detect the surrounding environment that is in the very bad or unfavorable state on the basis of the detection result of the acceleration sensor. In contrast to this, according to the technique disclosed in the present description, the surrounding environment that causes a near miss can be preferably detected on the basis of the result of object recognition of a video captured by the in-vehicle camera.

In the technique disclosed in the present description, near miss characteristics that trigger recording of a near miss video are detected basically on the basis of the result of object recognition of a video captured by the in-vehicle camera. However, the detection accuracy may be enhanced in combination with a range image or map information as necessary, and the detection results by various sensors including the acceleration sensor and the like may be used in combination. In addition, by quantifying a degree of a near miss to make a measurement as “near miss characteristic quantity”, near miss characteristics may be detected by determination based on a threshold value.

In the technique disclosed in the present description, considering the three kinds of near miss causes described above, the following six kinds of near miss characteristics are defined as near miss characteristics that trigger recording of a near miss video: (1) Approach of an object leading to a collision;

(2) Spin/slip; (3) Illegal driving (including the own vehicle and surrounding vehicles); (4) Sound; (5) Abnormality inside the vehicle room; and (6) Other abnormalities around the own vehicle. The near miss characteristics are each described below in conjunction with a detection method.

(1) Approach of Object Leading to Collision

As near miss characteristics related to an approach of an object leading to a collision, approaches of surrounding vehicles to each other, an approach of the own vehicle to a surrounding vehicle, an approach of an object other than vehicles (a pedestrian, an animal, roadwork, a guard rail, a utility pole, a building, or other obstacles), and the like can be mentioned. The approach of an object leading to a collision is caused by: driving of the own vehicle; and driving of a surrounding vehicle.

A target of object recognition for detecting the near miss characteristics includes surrounding vehicles, and the object other than vehicles. A video of surroundings of the own vehicle captured by the in-vehicle cameras such as the image capturing unit 2410 is subjected to the object recognition so as to recognize the surrounding vehicles and the object. Image-capturing also a region outside the visual field of the driver by the in-vehicle camera also enables an object at a blind spot position when turning left or right to be recognized.

Next, a distance between recognized surrounding vehicles, a distance between a recognized surrounding vehicle and the own vehicle, and a distance between a recognized object and the own vehicle are also measured. A distance can be measured with higher accuracy by using not only a video but also a range image. Subsequently, when it is determined by a vehicle speed that there is a high possibility that a collision between the surrounding vehicles, between the surrounding vehicle and the own vehicle, or between the object and the own vehicle will be inevitable or will occur, the result of the determination is detected as near miss characteristics. The near miss characteristic quantity that is quantified on the basis of a distance between objects and the time obtained by dividing the distance by a vehicle speed may be calculated. In addition, when the near miss characteristic quantity exceeds a predetermined threshold value, it is determined that near miss characteristics have been detected from the video. The detection may be used as a trigger of recording of the near miss video.

When the surrounding environment becomes very bad due to the weather such as snow and rain, freezing of a road surface, or the like, a stopping distance after stepping on a brake pedal gets longer. Accordingly, the near miss characteristics may be determined by assigning a weight to the calculated near miss characteristic quantity according to the surrounding environment. The operation can be carried out so as to facilitate the detection of near miss characteristics according to the weather and a road surface state. A target of the object recognition may further include a snow fall and a rainfall, or the detection result of the environment sensor (described above) included in the vehicle outside information detection part 2420 may be used in combination.

Incidentally, Patent Document 1 discloses a driving assistance device that controls starting of recording to a drive recorder on the basis of the result of recognizing an image of an external video. However, the driving assistance device merely recognizes lighting of a stop lamp, a hazard lamp, and a turn signal of a preceding vehicle. In other words, according to the technique disclosed in Patent Document 1, recording of a video is controlled by roughly determining a collision with a preceding vehicle. Therefore, it is considered that it is not possible to record a near miss video including approaches of surrounding vehicles to each other, an approach of the own vehicle to a surrounding vehicle other than the preceding vehicle, an approach to an obstacle other than vehicles, and the like.

(2) Spin/Slip

In general, a spin means that a tire slips off a road surface, which causes a vehicle body to rotate, and consequently a direction in which the vehicle is desired to travel largely differs from a direction of the vehicle body. In addition, even if a tire slips, if the vehicle body does not rotate so much, it is a slip. A spin/slip is abnormal driving of the own vehicle.

When a spin or a slip of the own vehicle occurs, a forward or backward road captured by the in-vehicle cameras such as the image capturing unit 2410 shows an abnormal track in a screen. Therefore, when near miss characteristics related to a spin or a slip are detected, a road is a target of the object recognition. A video of surroundings of the own vehicle captured by the in-vehicle cameras such as the image capturing unit 2410 is subjected to the object recognition to recognize a road, a division line drawn on a road (a roadway center line, a traffic lane dividing line, a roadway outside line, etc.), a road shoulder, a side strip, and the like. Subsequently, when the recognized road shows an abnormal track in a screen, the abnormal track is detected as near miss characteristics of a spin or a slip.

In addition, when a direction of steering becomes abnormal with respect to a traffic lane, the abnormality is detected as near miss characteristics. Using a steering angle of the steering wheel detected by the vehicle state detection unit 2110 in combination enables near miss characteristics to be detected with higher accuracy.

Moreover, in a case where the own vehicle moves in a manner different from a case where the own vehicle goes straight ahead or turns right or left, for example, when the whole screen of the video captured by the in-vehicle camera horizontally slides, the different movement is detected as near miss characteristics of a spin or a slip.

A road can be recognized on the basis of a division line (a roadway center line, a traffic lane dividing line, a roadway outside line, etc.). Further, the quantified near miss characteristic quantity may be calculated on the basis of, for example, the displacement amount of a road subjected to the object recognition in the screen, an angle of a direction of steering with respect to the direction of the recognized road, or the displacement amount, in the horizontal direction of the whole screen, of the video captured by the in-vehicle camera. Furthermore, when the near miss characteristic quantity exceeds a predetermined threshold value, it is determined that near miss characteristics have been detected. The detection may be used as a trigger of recording of the near miss video.

When the surrounding environment becomes very bad due to the weather such as snow and rain, freezing of a road surface or the like, abnormal driving of the own vehicle such as a spin and a slip easily occurs. Accordingly, the near miss characteristics may be determined by assigning a weight to the calculated near miss characteristic quantity according to the surrounding environment. The operation can be carried out so as to facilitate the detection of a near miss according to the weather and a road surface state. A target of the object recognition may further include a snow fall and a rainfall, or the detection result of the environment sensor (described above) included in the vehicle outside information detection part 2420 may be used in combination.

(3) Illegal Driving

A target of the illegal driving mentioned here includes both illegal driving of the own vehicle and illegal driving of a surrounding vehicle. This is because driving that violates traffic regulations (the Road Traffic Law, etc.), or traffic rules and manners easily leads to a near miss or an accident. The same applies to not only a violative act of the vehicle but also violative acts of a pedestrian and a bicycle. As near miss characteristics related to the illegal driving, it is possible to mention: traveling that deviates from a traffic lane (traveling that straddles a traffic lane dividing line for a long time, traveling that straddles a traffic lane dividing line in the timing that is not overtaking (including right-hand portion protruding traffic ban for overtaking) or in a situation in which there is no preceding vehicle); traveling on the side strip; an excess of a speed limit; not correctly stop at a stop line position; disregard of a traffic light; violation of one way traffic; violation of other road traffic signs; and violation related to nonperformance of signaling (when turning left, turning right, turning around, traveling slowly, stopping, driving backward, or changing a direction while traveling in the same direction, not correctly signal by a turn signal or the like, or drive differently from signaling). In addition, although not illegal driving of a vehicle, a violative act of a pedestrian or a bicycle that crosses a road at a place that is not a pedestrian crossing is also included in this category, and is treated, for convenience.

When near miss characteristics related to illegal driving are detected, a target of the object recognition includes a road, a division line drawn on a road (a roadway center line, a traffic lane dividing line, a roadway outside line, etc.), a stop line, a pedestrian crossing, a side strip, a traffic light, a road traffic sign, and (lighting of) a turn signal of a surrounding vehicle.

For example, a road traffic sign that is placed by a road or is drawn on a road surface is subjected to object recognition, thereby enabling contents of regulations (one way traffic, etc.) prescribed for a currently traveling road to be obtained. Information including, for example, traffic rules prescribed for a traveling road may be obtained by using map information as necessary. In addition, in the case of the own vehicle, a traveling state obtained by the object recognition of a road and scenery included in a video or a traveling state detected by the vehicle state detection unit 2110 is compared with road regulation information obtained on the basis of the object recognition of the road traffic sign and the map information. If the traveling state does not agree with the road regulation information, the traveling state is detected as near miss characteristics related to illegal driving of the own vehicle. Moreover, in the case of surrounding vehicles, a traveling state of surrounding vehicles that have been subjected to the object recognition from a video is analyzed, and is compared with road regulation information obtained on the basis of the object recognition of the road traffic sign and the map information. If the traveling state does not agree with the road regulation information (for example, when a surrounding vehicle appears from an alley while violating a one-way traffic rule), the traveling state is detected as near miss characteristics related to illegal driving of the surrounding vehicle.

With respect to stop line violation, a stop line on a road is subjected to the object recognition, and when it is determined, on the basis of the relationship between a current vehicle speed or acceleration of a vehicle and a stop line position, that the vehicle cannot stop, this state is detected as near miss characteristics related to illegal driving (disregard of a stop position). With respect to traffic light violation, a red signal or yellow signal of a traffic light is subjected to the object recognition, and when it is determined, on the basis of the relationship between a current vehicle speed or acceleration of a vehicle and a position of the traffic light subjected to the object recognition, that the vehicle cannot stop, this state is detected as near miss characteristics related to illegal driving (disregard of a traffic light). In the case of the own vehicle, the vehicle state detection unit 2110 detects a vehicle speed or acceleration of the own vehicle. In addition, in the case of surrounding vehicles, the vehicle speed or acceleration is detected by the object recognition.

With respect to violation related to nonperformance of signaling of the own vehicle, when lighting of a turn signal controlled by the body system control unit 2200 does not agree with a steering direction of the steering wheel detected by the vehicle state detection unit 2110, near miss characteristics related to the violation related to nonperformance of signaling of the own vehicle are detected. In addition, when near miss characteristics related to violation by not the own vehicle but a surrounding vehicle or a pedestrian are detected, a target of object detection is the surrounding vehicle or the pedestrian. With respect to violation related to nonperformance of signaling of a surrounding vehicle, a traveling state (stopping, turning to right or left, etc.) of the surrounding vehicle and lighting of a turn signal are both subjected to the object recognition, and when the traveling state does not agree with lighting of the turn signal (when the surrounding vehicle turns in a direction that differs from a lighting direction of the turn signal, or when the surrounding vehicle turns to right or left without lighting up the turn signal), near miss characteristics related to the violation related to nonperformance of signaling of the surrounding vehicle are detected.

When illegal driving of the own vehicle or a surrounding vehicle is detected, and further, when the above-described near miss characteristics related to the violation by the pedestrian are detected, the detection triggers recording of a near miss video.

(4) Sound

There is a case where such an approach of an object, or such abnormal driving of the own vehicle, that will lead to a collision is noticed by a driver or a passenger by visual observation or the five senses thereof although the approach or the abnormal driving cannot be detected by the object recognition. For example, when such an object that will lead to a collision approaches, or when a vehicle spins or slips, a driver sounds a klaxon horn and/or breaks suddenly, a collision noise occurs, and the driver or other passengers emit a sound (scream). These sounds are also observed inside the vehicle room. Accordingly, abnormal sounds observed inside the vehicle room are detected as near miss characteristics. The abnormal sounds are caused by: driving of the own vehicle; driving of a surrounding vehicle; and a surrounding environment.

The vehicle inside information detection unit 2500 includes the microphone that collects sounds inside the vehicle room (described above). A cry, a klaxon horn, a sudden braking sound, and a collision noise can be detected by recognizing the sounds inside the vehicle room collected by the microphone. The result of object recognition of a video captured by the in-vehicle camera, and the result of recognizing the sounds inside the vehicle room, may be complementarily used to detect near miss characteristics, thereby triggering recording of a near miss video. In addition, in a case where near miss characteristics are detected on the basis of sounds inside the vehicle room, the drive recorder may be configured to record not only the near miss video but also the sounds inside the vehicle room.

However, a conversation among passengers inside the vehicle room also includes privacy information. Therefore, from the viewpoint of privacy protection, sounds of persons other than a person, such as a driver, who has performed sound registration beforehand, may be modulated.

(5) Abnormality Inside Vehicle Room

A state (abnormal behavior) of a driver may cause the own vehicle to exhibit abnormal driving. An abnormal behavior of a driver may be detected as near miss characteristics related to abnormality inside the vehicle room, the abnormal behavior including inattentive or rambling driving, absence of a driver (including releasing of a handle for a long time), dozing while driving, a loss of consciousness, and the like. The abnormality inside the vehicle room is basically caused by driving of the own vehicle.

In a case where near miss characteristics related to abnormality inside the vehicle room are detected, a target of the object recognition includes a driver and other passengers. A state of the driver cannot be recognized from a video obtained by capturing the outside of the vehicle by the image capturing unit 2410. Accordingly, a video captured by the driver monitoring camera included in the vehicle inside state detection unit 2510 is subjected to the object recognition.

Incidentally, when near miss characteristics related to abnormality inside the vehicle room have been detected, recording of a near miss video is triggered, and further, the driver and other passengers may be notified of the near miss characteristics so as to avoid a risk. As a notification method, it is possible to mention: emitting an alarm sound; displaying on the instrument panel; using such a haptic device that applies the force, vibrations, a motion or the like to a seat; using a function (outputting a sound such as an alarm sound, displaying an image, or a vibration function) of an information terminal such as a smart phone possessed by a passenger; and the like.

(6) Other Abnormalities Around Own Vehicle

Near miss characteristics that are not included in the above-described (1) to (5) are detected as near miss characteristics related to other abnormalities around the own vehicle.

For example, in order to detect violation related to nonperformance of signaling of a surrounding vehicle as near miss characteristics, the turn signal of the surrounding vehicle is used as a target of the object recognition, which has been already described above. Sudden lighting of a stop lamp of a preceding vehicle, or lighting of a hazard lamp of the preceding vehicle, may be detected as near miss characteristics related to other abnormalities around the own vehicle. Sudden lighting of the stop lamp of the preceding vehicle enables a driver of the own vehicle to know that the preceding vehicle will suddenly stop. Therefore, the driver of the own vehicle is required to step on a brake pedal early, or to change a traffic lane to another traffic lane. In addition, lighting of the hazard lamp of the preceding vehicle enables a driver of the own vehicle to know that the preceding vehicle is stopping or parking. Therefore, the driver of the own vehicle is required to change a traffic lane to another traffic lane.

Incidentally, targets of the object recognition for detecting each of the near miss characteristics, and information (sensor information, etc.) used for an objective other than the object recognition are summarized in the following Table 1.

TABLE 1

| NEAR MISS | OBJECTS TO BE | OTHER SENSOR |
|---|---|---|
| CHARACTERISTICS | RECOGNIZED | INFORMATION |
| APPROACH OF OBJECT | SURROUNDING VEHICLES, | RANGE IMAGE, |
| | OBJECT, WEATHER | ENVIRONMENTAL |
| | | INFORMATION |
| SPIN/SLIP | ROAD (DIVISION LINE, | DIRECTION OF STEERING, |
| | ROAD SHOULDER, SIDE | ENVIRONMENTAL |
| | STRIP), WEATHER | INFORMATION |
| ILLEGAL DRIVING | ROAD TRAFFIC SIGN, | MAP INFORMATION, |
| | DIVISION LINE OF ROAD, | CONTROL SIGNAL OF LAMP |
| | SIDE STRIP, PEDESTRIAN | |
| | CROSSING, TRAFFIC | |
| | LIGHT, TURN SIGNAL, | |
| | SURROUNDING VEHICLES, | |
| | WALKERS | |
| SOUND INSIDE VEHICLE | | SOUND INSIDE VEHICLE |
| ROOM | | ROOM |
| ABNORMALITY INSIDE | DRIVER | BIOLOGICAL INFORMATION |
| VEHICLE ROOM | | |
| OTHER SURROUNDING | STOP LAMP AND HAZARD | |
| ABNORMALITIES | LAMP OF PRECEDING | |
| | VEHICLE | |

B-2. System Configuration for Triggering Recording of Near Miss Video

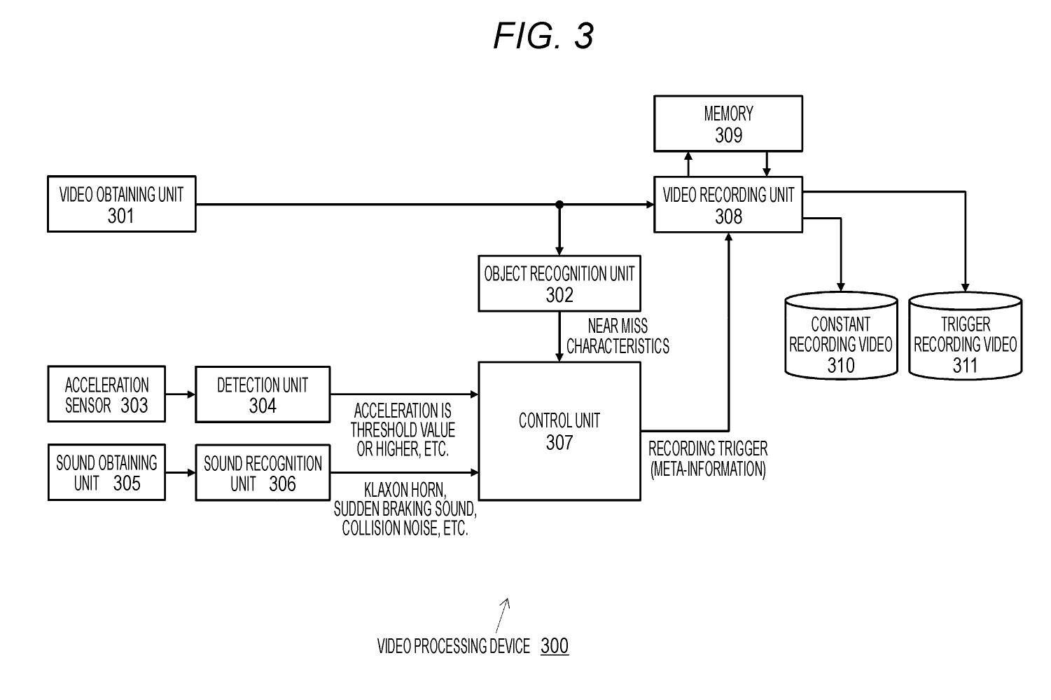

FIG. 3 schematically illustrates a functional configuration of a video processing device 300 that controls recording of a near miss video. The video processing device 300 shown in the figure is provided with a video obtaining unit 301, an object recognition unit 302, an acceleration sensor 303, a detection unit 304, a sound obtaining unit 305, a sound recognition unit 306, a control unit 307, a video recording unit 308, and a memory 309. It is assumed that the video processing device 300 is realized as, for example, one function of the vehicle control system 100 shown in FIG. 1, and is used by being provided in a vehicle.

The video obtaining unit 301 is provided in the vehicle, and obtains a video captured by one or more in-vehicle cameras that image-capture the outside of the vehicle (surroundings of the vehicle) and the inside of the vehicle room. The in-vehicle cameras mentioned here correspond to, for example, the image capturing unit 2410, and the driver monitoring camera included in the vehicle inside state detection unit 2510, in the vehicle control system 2000 shown in FIG. 1. As described with reference to FIG. 2, the image capturing unit 2410 includes the plurality of in-vehicle cameras, and image-captures surroundings of the vehicle.

The object recognition unit 302 subjects a video of surroundings of the vehicle and a video of the inside of the vehicle room to the object recognition, the videos having been obtained by the video obtaining unit 301, and detects near miss characteristics on the basis of the result of the recognition. The object recognition unit 302 corresponds to the vehicle outside information detection unit 2400 that receives image data captured by the image capturing unit 2410, and the vehicle inside information detection unit 2500 that receives image data captured by the driver monitoring camera. The definition of the near miss characteristics detected by the object recognition unit 302, and the objects to be recognized for detecting each of the near miss characteristics, have already been described (refer to Table 1).

The object recognition unit 302 may be configured to perform weighting processing according to the weather by, for example, when near miss characteristics related to a spin/slip is detected, determining the weather on the basis of the result of subjecting a snow fall or a rainfall appearing in a video to the object recognition (described above). Alternatively, the weather or meteorological information detected by the environment sensor included in the vehicle outside information detection part 2420 may be used.

The acceleration sensor 303 measures an acceleration applied to the vehicle. The detection unit 304 detects a change in acceleration measured by the acceleration sensor 303, and when the change in acceleration becomes a predetermined threshold value or higher, outputs a detection signal to the control unit 307. The acceleration sensor 303 is included in, for example, the vehicle state detection unit 2110 in the vehicle control system 2000 shown in FIG. 1. In addition, the detection unit 304 corresponds to the drive system control unit 210 that performs computation processing by using a signal input from the vehicle state detection unit 2110.

The acceleration measured by the acceleration sensor 303 changes by a shock caused by an accident of the vehicle, or the driving operation of sudden braking, abrupt steering, or the like resulting from a near miss, and also changes by, for example, a difference in level, or recesses and projections, of a road surface, or how the driver drives. Therefore, the detection signal output from the detection unit 304 does not always indicate an accident or a near miss.

The sound obtaining unit 305 collects sounds generated inside the vehicle room and around the vehicle, and outputs a sound signal to the sound recognition unit 306. The sound recognition unit 306 performs sound recognition processing, and when an abnormal sound such as a cry inside the vehicle room, a klaxon horn, a sudden braking sound, and a collision noise is detected, outputs a detection signal to the control unit 307. It is assumed that among the near miss characteristics defined in the technique disclosed in the present description, the abnormality inside the vehicle room is not based on the result of object recognition of a video captured by the in-vehicle camera, but is detected by the sound recognition unit 306.

The sound obtaining unit 305 corresponds to, for example, the sound sensor included in the vehicle outside information detection part 2420 in the vehicle control system 2000 shown in FIG. 1, and the microphone that collects sounds inside the vehicle room, the microphone being included in the vehicle inside state detection unit 2510. In addition, the sound recognition unit 306 corresponds to the vehicle outside information detection unit 2400 that performs various kinds of recognition and detection processing on the basis of a received signal from the vehicle outside state detection part 2420, and the vehicle inside information detection unit 2500 that detects a state inside the vehicle on the basis of an input signal from the vehicle inside state detection unit 2510.

Basically, according to a detection signal of near miss characteristics output from the object recognition unit 302, the control unit 307 controls trigger recording of a video of the in-vehicle camera obtained by the video obtaining unit 301. The control unit 307 corresponds to, for example, the integrated control unit 2600 or the microcomputer 2610 in the vehicle control system 2000 shown in FIG. 1. Alternatively, the control unit 307 can also be realized by a plurality of control units included in the vehicle control system 2000.

The video processing device 300 shown in FIG. 3 records a near miss video, as trigger recording, as a file different from constant recording (overwrite and save in a finite time period) of a video obtained by the video obtaining unit 301. However, there is also a trigger recording method in which meta-information that specifies an overwrite protection section of a near miss video is added to a storage device that performs constant recording.

In response to a detection signal of near miss characteristics that has been input from the object recognition unit 302, the control unit 307 controls extraction processing of extracting a near miss video from a video captured by the in-vehicle camera. More specifically, the control unit 307 outputs a trigger signal (recording trigger) that instructs trigger recording of the near miss video, and generates meta-information that specifies overwrite protection of a section in which near miss characteristics have been detected. In addition, the control unit 307 may be configured to control the output of the recording trigger with reference to not only the detection signal of the near miss characteristics but also a detection signal related to the change in acceleration from the detection unit 304. Moreover, the control unit 307 may be configured to control the output of a recording trigger on the basis of the result of recognizing a sound (a klaxon horn, a sudden braking sound, a collision noise, etc.) indicating an abnormality inside the vehicle room by the sound recognition unit 306.

The video recording unit 308 corresponds to, for example, a large capacity storage that is capable of overwriting and saving, such as a magnetic storage device, a semiconductor storage device, an optical storage device, or a magneto-optical storage device, the large capacity storage being included in the storage unit 2690 in the integrated control unit 2600. In addition, the memory 309 is an RAM, an EEPROM, or the like included in the storage unit 2690, and can be used to temporarily save working data.

The video recording unit 308 records a video captured by the in-vehicle camera, which is obtained by the video obtaining unit 301, as a constant recording video 310 with the video overwritten and saved in a finite time period.

Moreover, when the video recording unit 308 receives a recording trigger from the control unit 307, the video recording unit 308 determines that a video that is being obtained by the video obtaining unit 301 is a near miss video, and records a video including before and after the occurrence of the recording trigger as a trigger recording video 311 that is a file different from the constant recording video. When trigger recording is executed, the video recording unit 308 is capable of temporarily saving a video including before and after the recording trigger in the memory 309.

However, there is also a trigger recording method in which in response to a recording trigger from the control unit 307, the video recording unit 308 adds meta-information that specifies an overwrite protection section in the constant recording video 310 so as to protect a near miss video.

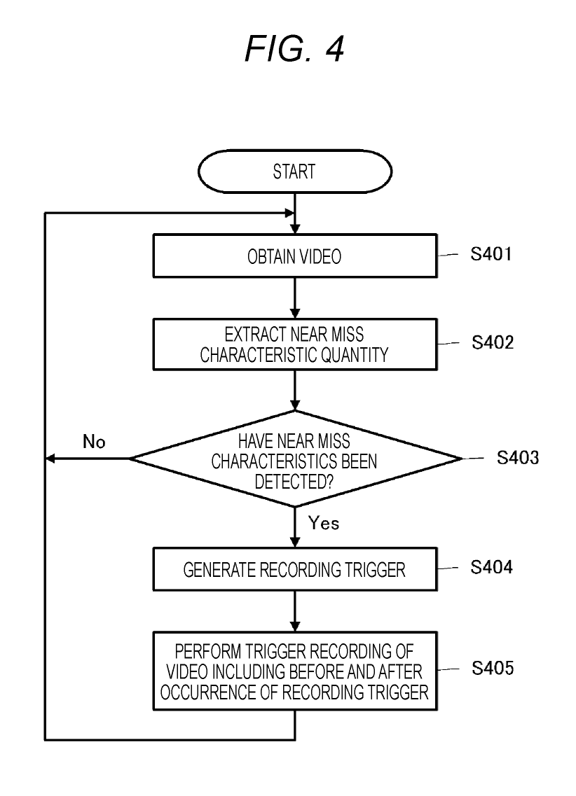

FIG. 4 shows, in a flowchart form, a processing procedure for controlling trigger recording of a near miss video by the video processing device 300 shown in FIG. 3.

The video obtaining unit 301 is provided in the vehicle, and obtains a video captured by one or more in-vehicle cameras that image-capture the outside of the vehicle (surroundings of the vehicle) and the inside of the vehicle room (step S401).

Incidentally, it is assumed that in the video processing device 300, constant recording of a video obtained by the video obtaining unit 301 is performed in parallel with the trigger recording control of a near miss video.

The object recognition unit 302 subjects a video of surroundings of the vehicle and a video of the inside of the vehicle room to the object recognition, the videos having been obtained by the video obtaining unit 301, and extracts a near miss characteristic quantity indicating a degree of a near miss (step S402). The weighting processing (described above) may be performed for the near miss characteristic quantity according to a surrounding environment of the own vehicle, such as the weather.

Next, the object recognition unit 302 compares the near miss characteristic quantity with a predetermined threshold value to make a large and small comparison (step S403). Here, when the near miss characteristic quantity exceeds the threshold value, it is determined that near miss characteristics have been detected (YES in the step S403). The object recognition unit 302 outputs a detection signal of near miss characteristics to the control unit 307. Subsequently, the control unit 307 outputs a recording trigger to the video recording unit 308 (step S404), and instructs trigger recording of the near miss video.

The control unit 307 may be configured to control the output of the recording trigger with reference to not only the detection signal of the near miss characteristics from the object recognition unit 302 but also a detection signal related to the change in acceleration from the detection unit 304. Moreover, the control unit 307 may be configured to control the output of a recording trigger on the basis of the result of recognizing a sound (a klaxon horn, a sudden braking sound, a collision noise, etc.) indicating an abnormality inside the vehicle room by the sound recognition unit 306.

The video recording unit 308 records a video captured by the in-vehicle camera, which is obtained by the video obtaining unit 301, as the constant recording video 310 with the video overwritten and saved in a finite time period.

Subsequently, when the video recording unit 308 receives a recording trigger from the control unit 307, the video recording unit 308 determines that a video that is being obtained by the video obtaining unit 301 is a near miss video, and records a video including before and after the occurrence of the recording trigger as the trigger recording video 311 that is a file different from the constant recording video (step S405). When trigger recording is executed, the video recording unit 308 is capable of temporarily saving a video including before and after the recording trigger in the memory 309.

Alternatively, the processing executed in the above-described steps S404 and S405 may be replaced with the processing of generating meta-information that specifies overwrite protection of a section in which near miss characteristics have been detected, and then adding this meta-information to the constant recording video 310.

For example, while the video processing device 300 functions as a drive recorder, processing in each of the steps S401 to S405 described above is repeatedly executed.

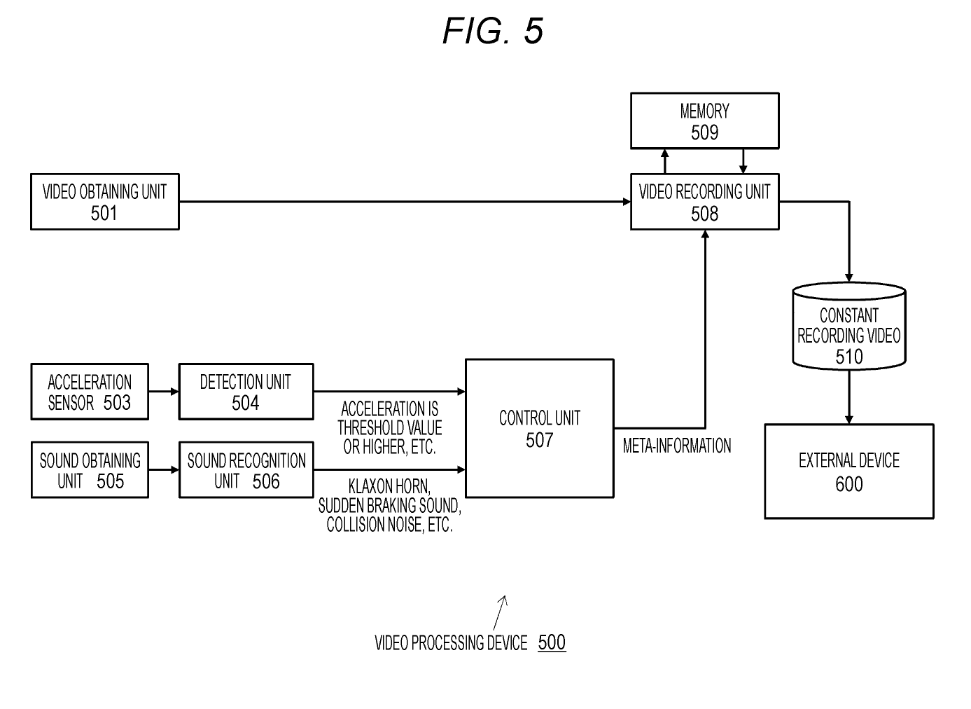

FIG. 5 shows a functional configuration of the video processing device 500 as a modified example of the video processing device 300 shown in FIG. 3. The video processing device 500 shown in the figure is provided with a video obtaining unit 501, an acceleration sensor 503, a detection unit 504, a sound obtaining unit 505, a sound recognition unit 506, a control unit 507, a video recording unit 508, and a memory 509. It is assumed that the video processing device 500 is realized as, for example, one function of the vehicle control system 100 shown in FIG. 1, and is used by being provided in a vehicle. It is assumed that among functional modules with which the video processing device 500 is provided, functional modules that have the same names as those of functional modules included in the video processing device 300 shown in FIG. 3 have the same functions respectively.

The video obtaining unit 501 is provided in the vehicle, and obtains a video captured by one or more in-vehicle cameras that image-capture the outside of the vehicle (surroundings of the vehicle) and the inside of the vehicle room (same as above). The video recording unit 508 includes a large capacity storage, and records a video obtained by the video obtaining unit 501 as a constant recording video 510. For convenience of explanation, it is assumed that the constant recording video 510 is recorded without being overwritten.

The acceleration sensor 503 measures an acceleration applied to the vehicle. The detection unit 504 detects a change in acceleration measured by the acceleration sensor 503, and when the change in acceleration becomes a predetermined threshold value or higher, outputs a detection signal to the control unit 507.

The sound obtaining unit 505 collects sounds generated inside the vehicle room and around the vehicle, and outputs a sound signal to the sound recognition unit 506. The sound recognition unit 506 performs sound recognition processing, and when an abnormal sound such as a cry inside the vehicle room, a klaxon horn, a sudden braking sound, and a collision noise is detected, outputs a detection signal to the control unit 507.

From the detection signal related to the change in acceleration detected by the detection unit 504, and from the detection signal related to an abnormal sound (a klaxon horn, a sudden braking sound, a collision noise, etc.) recognized by the sound recognition unit 506, the control unit 507 outputs meta-information associated with the change in acceleration, and associated with sounds that have occurred inside the vehicle room and outside the vehicle, to the video recording unit 508. The video recording unit 508 records the constant recording video 510 with the meta-information added thereto.

A main point of difference between the video processing device 500 and the video processing device 300 shown in FIG. 3 is that the extraction processing of extracting a near miss video is performed by an external device 600 that is installed not in the video processing device 500 provided in the vehicle, but outside the vehicle (or physically independently from the video processing device 500). The external device 600 obtains the constant recording video 510 recorded by the video processing device 500 to perform object recognition processing of the video, and performs near miss video extraction processing as post-processing by appropriately referring to the added meta-information as well.

The external device 600 is, for example, an information terminal such as a PC and a tablet, or a server installed on a wide area network such as the Internet. A means by which the external device 600 obtains the constant recording video 510 from the video processing device 500 is optional. For example, it is possible to mention a method in which on the video processing device 500 side, the constant recording video 510 is recorded in a recording medium such as a CD and a DVD, or in a removable memory device (a USB memory, etc.), and such a recording medium or memory device of the external device 600 is loaded into, or mounted to, the external device 600. In addition, the constant recording video 510 may be transmitted together with the meta-information by connecting between the video processing device 500 and the external device 600 by a video transmission cable such as HDMI (registered trademark). Alternatively, the constant recording video 510 may be subjected to file transfer between the video processing device 500 and the external device 600 through the communication network 2010. Moreover, the constant recording video may be saved in an external server by wireless communication or the like, and may be concurrently subjected to extraction processing on the server.

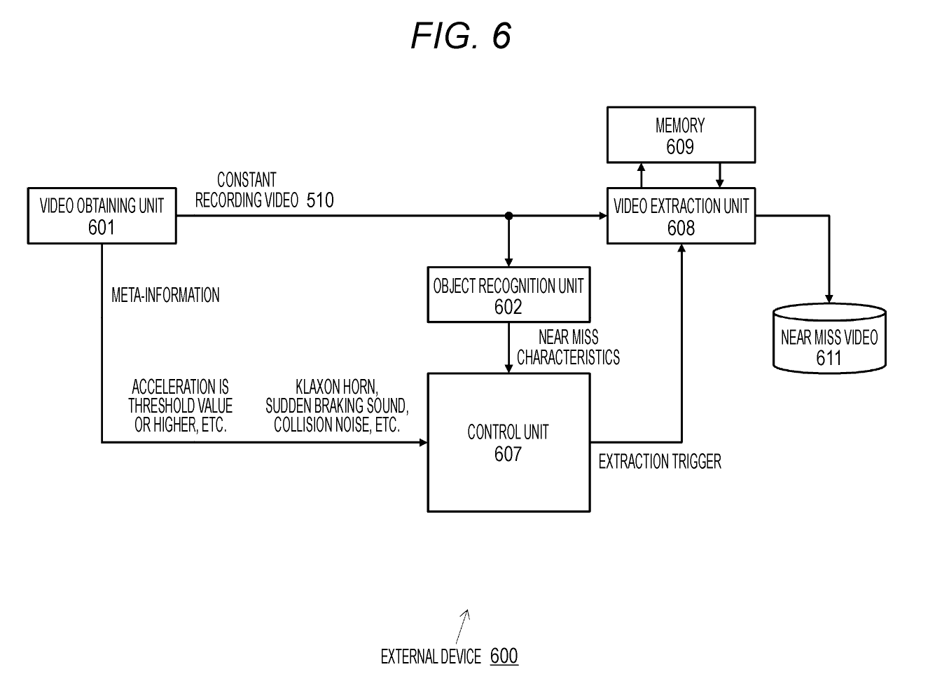

FIG. 6 schematically illustrates a functional configuration for performing processing of extracting a near miss video by the external device 600. The external device 600 is provided with a video obtaining unit 601, an object recognition unit 602, a control unit 607, a video extraction unit 608, and a memory 609.

The video obtaining unit 601 obtains a constant recording video 510 from the video processing device 500 together with meta-information by an arbitrary means, for example: through a recording medium or a memory device; using a video transmission medium such as HDMI (registered trademark); through the communication network 2010; or the like. The video obtaining unit 601 outputs the constant recording video 510 to the video extraction unit 608, and assigns the meta-information added to the constant recording video 510 to the control unit 607.

The object recognition unit 602 subjects the constant recording video 510 obtained by the video obtaining unit 601 to the object recognition, and detects near miss characteristics on the basis of the result of the recognition. The definition of the near miss characteristics detected by the object recognition unit 602, and the objects to be recognized for detecting each of the near miss characteristics, have already been described (refer to Table 1).

Basically, according to a detection signal of near miss characteristics output from the object recognition unit 602, the control unit 607 controls processing of extracting a near miss video from the constant recording video 510 by the video extraction unit 608. More specifically, in response to an input of a detection signal of near miss characteristics from the object recognition unit 602, the control unit 607 outputs an extraction trigger that instructs the video extraction unit 608 to extract a near miss video.

In addition, the control unit 507 may be configured to control the output of the extraction trigger with reference to not only the detection signal of the near miss characteristics but also a detection signal related to the change in acceleration described in the meta-information as appropriate. Moreover, the control unit 607 may be configured to control the output of the extraction trigger on the basis of the result of recognizing a sound (a klaxon horn, a sudden braking sound, a collision noise, etc.) indicating an abnormality inside the vehicle room described in the meta-information.

The video extraction unit 608 determines that a near miss is occurring at a reproduction position corresponding to the extraction trigger output from the control unit 607. The video extraction unit 608 then extracts a video including before and after the reproduction position corresponding to the extraction trigger, and records the video as the near miss recorded video 611. In order to extract and record a near miss video, the video extraction unit 608 is capable of temporarily saving a video including before and after the extraction trigger in the memory 609.

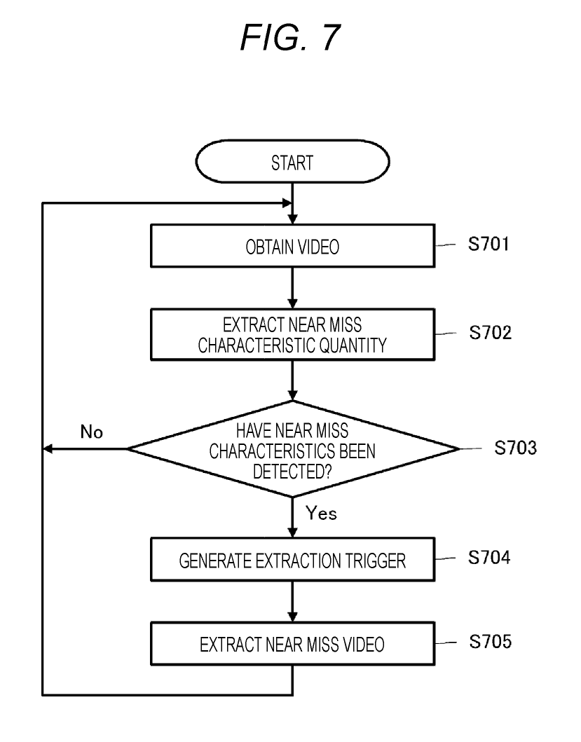

FIG. 7 shows, in a flowchart form, a processing procedure for extracting a near miss video from the constant recording video 510 in the external device 600 shown in FIG. 6.

The video obtaining unit 601 obtains the constant recording video 510 from the video processing device 500 (step S701).

The object recognition unit 602 subjects the constant recording video 510 obtained by the video obtaining unit 301 to the object recognition, and extracts a near miss characteristic quantity indicating a degree of a near miss (step S702). The weighting processing (described above) may be performed for the near miss characteristic quantity according to a surrounding environment of the own vehicle, such as the weather.

Next, the object recognition unit 602 compares the near miss characteristic quantity with a predetermined threshold value to make a large and small comparison (step S603). Here, when the near miss characteristic quantity exceeds the threshold value, it is determined that near miss characteristics have been detected (YES in the step S603). The object recognition unit 602 outputs a detection signal of near miss characteristics to the control unit 607. Subsequently, the control unit 607 outputs an extraction trigger to the video extraction unit 608 (step S704), and instructs extraction of the near miss video.

The control unit 607 may be configured to control the output of the extraction trigger with reference to not only the detection signal of the near miss characteristics from the object recognition unit 602 but also the information of the change in acceleration described in the meta-information. Moreover, the control unit 607 may be configured to control the output of the extraction trigger on the basis of the result of recognizing a sound (a klaxon horn, a sudden braking sound, a collision noise, etc.) indicating an abnormality inside the vehicle room described in the meta-information.

Subsequently, the video extraction unit 608 determines that a near miss is occurring at a reproduction position corresponding to the extraction trigger output from the control unit 607. The video extraction unit 608 then extracts a video including before and after the reproduction position corresponding to the extraction trigger, and records the video as the near miss recorded video 611 (step S705). In order to extract and record a near miss video, the video extraction unit 608 is capable of temporarily saving a video including before and after the extraction trigger in the memory 609.

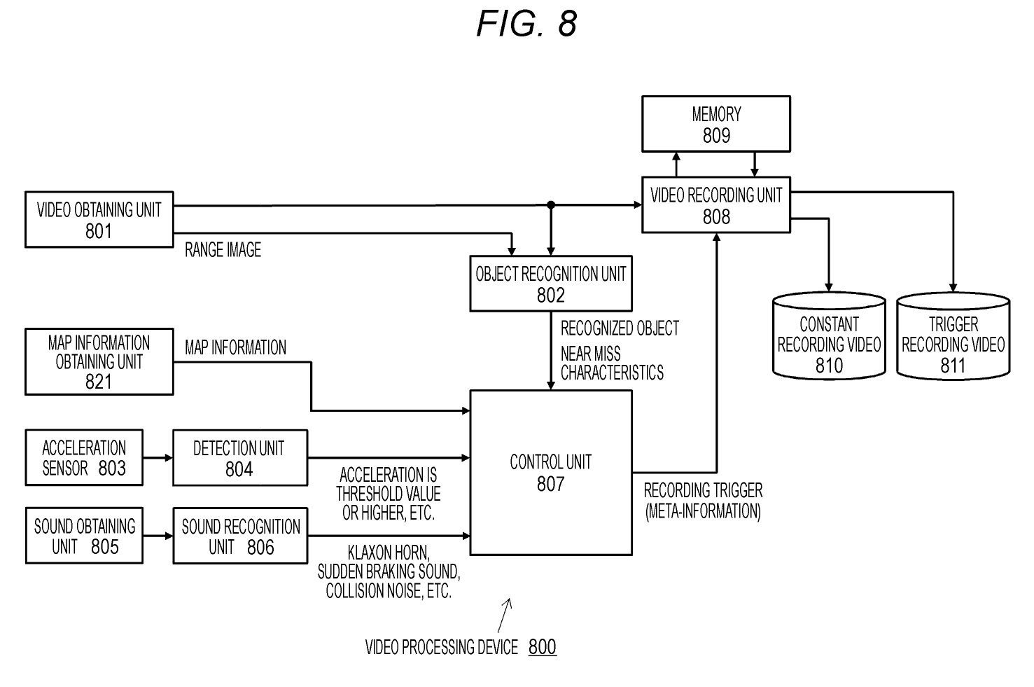

FIG. 8 shows a functional configuration of the video processing device 800 as another modified example of the video processing device 300 shown in FIG. 3. The video processing device 800 shown in the figure is provided with a video obtaining unit 801, an acceleration sensor 803, a detection unit 804, a sound obtaining unit 805, a sound recognition unit 806, a control unit 807, a video recording unit 808, a memory 809, and a map information obtaining unit 821. It is assumed that the video processing device 800 is realized as, for example, one function of the vehicle control system 100 shown in FIG. 1, and is used by being provided in a vehicle. It is assumed that among functional modules with which the video processing device 800 is provided, functional modules that have the same names as those of functional modules included in the video processing device 300 shown in FIG. 3 have the same functions respectively.

The video obtaining unit 801 is provided in the vehicle, and obtains a video captured by one or more in-vehicle cameras that image-capture the outside of the vehicle (surroundings of the vehicle) and the inside of the vehicle room (same as above). In addition, a stereo camera is used as the in-vehicle camera, and the video obtaining unit 801 obtains a range image together.

The object recognition unit 802 subjects a video of surroundings of the vehicle and a video of the inside of the vehicle room to the object recognition, the videos having been obtained by the video obtaining unit 801, detects near miss characteristics on the basis of the result of the recognition, and outputs information of the recognized object and a detection signal of the near miss characteristics to the control unit 807.

In addition, the object recognition unit 802 is capable of obtaining a distance of a surrounding vehicle or a distance of such an object that will become any other object obstacles (a surrounding vehicle, a pedestrian, an animal, roadwork, a guard rail, a utility pole, building, and other obstacles) by using the range image obtained by the video obtaining unit 801. Therefore, near miss characteristics related to an approach of an object leading to a collision can be detected with higher accuracy.

The acceleration sensor 803 measures an acceleration applied to the vehicle. The detection unit 804 detects a change in acceleration measured by the acceleration sensor 803, and when the change in acceleration becomes a predetermined threshold value or higher, outputs a detection signal to the control unit 807.

The sound obtaining unit 805 collects sounds generated inside the vehicle room and around the vehicle, and outputs a sound signal to the sound recognition unit 806. The sound recognition unit 806 performs sound recognition processing, and when an abnormal sound such as a cry inside the vehicle room, a klaxon horn, a sudden braking sound, and a collision noise is detected, outputs a detection signal to the control unit 807.

The map information obtaining unit 821 obtains map information at a current position of the vehicle on the basis of position information that is generated by the positioning unit 2640 on the basis of, for example, a GNSS signal received from a GNSS satellite.

The control unit 807 controls trigger recording of a video of the in-vehicle camera obtained by the video obtaining unit 801 according to the information of the recognized object output from the object recognition unit 802 and the detection signal of the near miss characteristics.

For example, in response to an input of a detection signal of near miss characteristics from the object recognition unit 802, the control unit 807 outputs, to the video recording unit 808, a trigger signal (recording trigger) that instructs trigger recording of the near miss video.

In addition, the control unit 807 is capable of identifying information associated with regulations (one way traffic, etc.) that are applied to a road along which the vehicle currently travels on the basis of the object (a road traffic sign, a division line (a roadway center line, a traffic lane dividing line, a roadway outside line, etc.), a side strip, a pedestrian crossing, a traffic light, etc.) recognized by the object recognition unit 802, and the map information obtained by the map information obtaining unit 821, and is capable of detecting Illegal driving (illegal driving of the own vehicle or a surrounding vehicle, and further a violative act carried out by a pedestrian or a bicycle) with high accuracy to control the output of the recording trigger.

In addition, the control unit 807 may be configured to control the output of the recording trigger with reference to not only the detection signal of the near miss characteristics from the object recognition unit 802 but also a detection signal related to the change in acceleration from the detection unit 804. Moreover, the control unit 807 may be configured to control the output of a recording trigger on the basis of the result of recognizing a sound (a klaxon horn, a sudden braking sound, a collision noise, etc.) indicating an abnormality inside the vehicle room by the sound recognition unit 806.

The video recording unit 808 records a video captured by the in-vehicle camera, which is obtained by the video obtaining unit 801, as a constant recording video 810 with the video overwritten and saved in a finite time period.

Moreover, when the video recording unit 808 receives a recording trigger from the control unit 807, the video recording unit 808 determines that a video that is being obtained by the video obtaining unit 801 is a near miss video, and records a video including before and after the occurrence of the recording trigger as a trigger recording video 811 that is a file different from the constant recording video. In order to perform trigger recording, the video recording unit 808 is capable of temporarily saving a video including before and after the recording trigger in the memory 809.

In the video processing device 800, the trigger recording control of a near miss video can be realized by a processing procedure similar to that of the flowchart shown in FIG. 4, and therefore an explanation thereof will be omitted here.

It should be noted that the video processing devices 300, 500, and 800 described above can also be implemented as a module for the integrated control unit 2600 in the vehicle control system 2000 (for example, an integrated circuit module that includes one die), or can also be implemented by combining a plurality of control units that include the integrated control unit 2600 and other control units.

In addition, the function realized by the video processing devices 300, 500, and 800 (for example, a function of subjecting a near miss video to trigger recording) can be realized by a computer program, and such a computer program may be executed by any of the control units included in the vehicle control system 2000. Moreover, such a computer program can also be provided with the computer program stored in a computer-readable recording medium. As the recording medium, a magnetic disk, an optical disk, a magneto-optical disk, a flash memory, and the like can be mentioned. Further, such a computer program can also be delivered via a network.

By applying the technique disclosed in the present description to a drive recorder, the accuracy at the time of subjecting a near miss video to trigger recording is enhanced, which enables recording of useless videos resulting from false detection of a near miss to be suppressed. As the result, even in an aspect of the utilization of videos, a labor for searching and managing near miss videos from the drive recorder can be largely reduced.

Furthermore, trigger recording of a near miss video, which uses the technique disclosed in the present description, is performed as real time processing during driving of the vehicle, and can also be performed as post-processing after driving is ended (refer to, for example, FIGS. 5 to 7). In the latter case, a main body of the drive recorder does not require dedicated hardware. Trigger recording of a near miss video, which uses the technique disclosed in the present description, can also be applied to a recorded video of the drive recorder that has already been operated.

### INDUSTRIAL APPLICABILITY

Up to this point, the technique disclosed in the present description has been described in detail with reference to specific embodiments. However, it is obvious that a person skilled in the art can correct or substitute the foregoing embodiments without departing from the gist of the technique disclosed in the present description.

The technique disclosed in the present description can be applied to various kinds of vehicles including, for example, an automobile (including a gasoline car and a diesel car), an electric vehicle, a hybrid electric vehicle, a motorcycle, a bicycle, and a personal mobility, and further to a moving object having a form other than vehicles traveling along a road.

The drive recorder to which the technique disclosed in the present description is applied extracts near miss characteristics by recognizing an object in a video captured by the in-vehicle camera, and performs trigger recording. However, as a matter of course, the drive recorder can be configured to perform trigger recording by using information detected by the acceleration sensor or various kinds of sensors in combination.

The processing of detecting near miss characteristics by recognizing an object from a video recorded by the drive recorder may be performed as real time processing by a traveling automobile, or may be performed as post-processing after driving of the automobile ends.

In addition, the processing of detecting near miss characteristics by recognizing an object from a video recorded by the drive recorder may be performed not only by the main body of the drive recorder, but also by an apparatus (for example, on a server) other than the main body of the drive recorder.

In short, the technique disclosed in the present description has been described in the form of illustration, and should not be construed as limiting the contents of the present description. In order to determine the gist of the technique disclosed in the present description, the claims should be taken into consideration.

It should be noted that the technique disclosed in the present description can also be configured as follows:

(1) A video processing device including:

an object recognition unit that, on the basis of a result of recognizing an object included in a video obtained by image-capturing an outside or an inside of a vehicle, detects characteristics of a scene in which there is a possibility of leading to an accident; and a control unit that, according to detection of the characteristics, controls processing of the video.

(1-1) The video processing device set forth in the above-described (1), in which

the control unit controls recording of the video according to the characteristics.

(1-2) The video processing device set forth in the above-described (1), further including

a trigger recording unit (that records a video including before and after a near miss),

in which the control unit controls recording of the video in the trigger recording unit according to the characteristics.

(1-3) The video processing device set forth in the above-described (1), further including

a constant recording unit that constantly overwrites and records the video in a predetermined finite time period,

in which the control unit controls overwrite protection of the constant recording unit on the basis of the characteristics.

(1-4) The video processing device set forth in the above-described (1), further including

one or more image capturing units with which the vehicle is equipped, and each of which is image-captures the outside or the inside of the vehicle.

(2) The video processing device set forth in the above-described (1), in which

the object recognition unit detects, as the characteristics, characteristics related to an approach of an object recognized from the video.

(3) The video processing device set forth in the above-described (1), in which

the object recognition unit detects, as the characteristics, characteristics related to approaches of surrounding vehicles to each other, the surrounding vehicles having been subjected to object recognition.

(4) The video processing device set forth in the above-described (1), in which

the object recognition unit detects, as the characteristics, characteristics related to an approach of the vehicle to a surrounding vehicle subjected to object recognition or other objects.

(5) The video processing device set forth in any of the above-described (2) to (4), in which

the object recognition unit detects characteristics related to the approach by further referring to a range image.

(6) The video processing device set forth in any of the above-described (2) to (5), further including a vehicle outside information detection part that detects a surrounding environment of the vehicle,

in which the object recognition unit detects characteristics related to the approach further in consideration of the surrounding environment.

(7) The video processing device set forth in the above-described (1), in which

the object recognition unit detects, as the characteristics, characteristics related to a spin or slip of the vehicle on the basis of a track, in a screen, of a road recognized from the video.

(8) The video processing device set forth in the above-described (7), in which

the object recognition unit recognizes, from the video, a road on the basis of a division line drawn on a road, a road shoulder, and a side strip.

(9) The video processing device set forth in the above-described (1), further including

a vehicle state detection unit that detects a direction of a steering of the vehicle,

in which the object recognition unit detects, as the characteristics, characteristics related to a spin or slip of the vehicle on the basis of an angle between a road recognized from the video and a direction of the steering.

(10) The video processing device set forth in any of the above-described (7) to (9), further including a vehicle outside information detection part that detects a surrounding environment of the vehicle,

in which

the object recognition unit detects characteristics related to a spin or slip of the vehicle in consideration of the surrounding environment.

(11) The video processing device set forth in the above-described (1), in which

the object recognition unit detects, as the characteristics, characteristics related to illegal driving of the vehicle or surrounding vehicles thereof, and a violative act of a pedestrian.

(12) The video processing device set forth in the above-described (11), in which

the object recognition unit recognizes a traffic lane or a side strip from the video, and detects characteristics related to traveling of the vehicle deviating from the traffic lane.

(13) The video processing device set forth in the above-described (11), in which

the object recognition unit recognizes a traffic lane or a side strip and surrounding vehicles from the video, and detects characteristics related to traveling of the surrounding vehicles deviating from the traffic lane.

(14) The video processing device set forth in the above-described (11), in which

the object recognition unit obtains information associated with regulations prescribed for a traveling road on the basis of a result of object recognition of the video, and when a traveling state of the vehicle or a surrounding vehicle thereof does not agree with the regulations, detects characteristics related to illegal driving.

(15) The video processing device set forth in the above-described (14), in which

information associated with regulations prescribed for a traveling road is obtained further on the basis of map information.

(16) The video processing device set forth in the above-described (11), in which

the object recognition unit recognizes, from the video, at least one of a road traffic sign installed on the roadside, a road traffic sign drawn on a road surface, a stop line position drawn on a road, and a traffic light, and when at least one of violation of a road traffic sign, disregard of a stop line position, and disregard of a traffic light, of the vehicle or a surrounding vehicle thereof, is detected, detects characteristics related to illegal driving.

(17) The video processing device set forth in the above-described (11), in which

the object recognition unit subjects a stop line on a road to object recognition, and in a case where it is determined, from a relationship between a vehicle speed or acceleration of the vehicle or a surrounding vehicle thereof and a stop line position, that stopping is impossible, detects characteristics related to illegal driving of stop position disregard.

(18) The video processing device set forth in the above-described (11), in which

the object recognition unit subjects a red signal or yellow signal of a traffic light to object recognition, and in a case where it is determined, from a relationship between a vehicle speed or acceleration of the vehicle or a surrounding vehicle thereof and a position of the traffic light subjected to the object recognition, that stopping is impossible, detects characteristics related to illegal driving of traffic light disregard.

(19) The video processing device set forth in the above-described (11), in which

the object recognition unit subjects both a traveling state of a surrounding vehicle and lighting of a lamp to object recognition, and when the traveling state does not agree with the lighting of the lamp, detects characteristics related to violation related to nonperformance of signaling of the surrounding vehicle.

(20) The video processing device set forth in the above-described (1), in which

the object recognition unit detects characteristics related to an abnormality inside a vehicle room of the vehicle.

(21) The video processing device set forth in the above-described (1), further including:

a sound obtaining unit that obtains sounds outside the vehicle or sounds inside a vehicle room; and

a sound obtaining unit that detects characteristics on the basis of a result of recognizing the sounds obtained by the sound obtaining unit.

(22) The video processing device set forth in the above-described (21), in which

the sound obtaining unit modulates sounds other than a sound registered beforehand.

(23) The video processing device set forth in the above-described (1), in which

the object recognition unit detects the characteristics on the basis of a result of recognition by a driver, the result of recognition being included in a video obtained by image-capturing the inside of the vehicle.

(24) The video processing device set forth in the above-described (1), further including

a vehicle inside state detection unit that detects a state of the driver,

in which the object recognition unit detects the characteristics by referring to a state of the driver together with the result of recognition by the driver.

(25) The video processing device set forth in the above-described (1), in which

the object recognition unit detects the characteristics on the basis of a result of subjecting lighting of a stop lamp or a hazard lamp of a preceding vehicle of the vehicle to object recognition.

(26) A video processing method including:

an object recognition step for, on the basis of a result of recognizing an object included in a video obtained by image-capturing an outside or an inside of a vehicle, detecting characteristics of a scene in which there is a possibility of leading to an accident; and

a control step for, according to detection of the characteristics, controlling processing of the video.

### REFERENCE SIGNS LIST

300 Video processing device
301 Video obtaining unit
302 Object recognition unit
303 Acceleration sensor
304 Detection unit
305 Sound obtaining unit
306 Sound recognition unit
307 Control unit
308 Video recording unit
309 Memory
310 Constant recording video
311 Trigger recording video
500 Video processing device
501 Video obtaining unit
503 Acceleration sensor
504 Detection unit
505 Sound obtaining unit
506 Sound recognition unit
507 Control unit
508 Video recording unit
509 Memory
510 Constant recording video
600 Video processing device
601 Video obtaining unit
602 Object recognition unit
607 Control unit
608 Video extraction unit
609 Memory
800 Video processing device
801 Video obtaining unit
802 Object recognition unit
803 Acceleration sensor
804 Detection unit
805 Sound obtaining unit
806 Sound recognition unit
807 Control unit
808 Video recording unit
809 Memory
810 Constant recording video
811 Trigger recording video
821 Map information obtaining unit
2000 Vehicle control system
2010 Communication network
2100 Drive system control unit
2110 Vehicle state detection unit
2200 Body system control unit
2300 Battery control unit
2310 Battery device
2400 Vehicle outside information detection unit
2410 Image capturing unit
2420 Vehicle outside information detection part
2500 Vehicle inside information detection unit
2510 Vehicle inside state detection unit
2600 Integrated control unit
2610 Microcomputer
2620 General-purpose communication interface
2630 Dedicated communication interface
2640 Positioning unit
2650 Beacon receiving unit
2660 Vehicle inside apparatus interface
2670 Sound-image output unit
2680 In-vehicle network interface
2690 Storage unit
710 Audio speaker
2720 Display unit
2730 Instrument panel
2760 Vehicle inside apparatus
2800 Input unit
2900 Vehicle
2910, 2912, 2914, 2916, 2918 Image capturing unit
2920, 2922, 2924 Vehicle outside information detection part
2926, 2928, 2930 Vehicle outside information detection part

1. A video processing device comprising:
an object recognition unit that, on the basis of a result of recognizing an object included in a video obtained by image-capturing an outside or an inside of a vehicle, detects characteristics of a scene in which there is a possibility of leading to an accident; and
a control unit that, according to detection of the characteristics, controls processing of the video.

2. The video processing device according to claim 1, wherein
the object recognition unit detects, as the characteristics, characteristics related to an approach of an object recognized from the video.

3. The video processing device according to claim 1, wherein
the object recognition unit detects, as the characteristics, characteristics related to approaches of surrounding vehicles to each other, the surrounding vehicles having been subjected to object recognition.

4. The video processing device according to claim 1, wherein
the object recognition unit detects, as the characteristics, characteristics related to an approach of the vehicle to a surrounding vehicle subjected to object recognition or other objects.

5. The video processing device according to claim 2, wherein
the object recognition unit detects characteristics related to the approach by further referring to a range image.

6. The video processing device according to claim 2, further comprising
a vehicle outside information detection part that detects a surrounding environment of the vehicle,
wherein the object recognition unit detects characteristics related to the approach further in consideration of the surrounding environment.

7. The video processing device according to claim 1, wherein
the object recognition unit detects, as the characteristics, characteristics related to a spin or slip of the vehicle on the basis of a track, in a screen, of a road recognized from the video.

8. The video processing device according to claim 7, wherein
the object recognition unit recognizes, from the video, a road on the basis of a division line drawn on a road, a road shoulder, and a side strip.

9. The video processing device according to claim 1, further comprising a vehicle state detection unit that detects a direction of a steering of the vehicle,
wherein the object recognition unit detects, as the characteristics, characteristics related to a spin or slip of the vehicle on the basis of an angle between a road recognized from the video and a direction of the steering.

10. The video processing device according to claim 7, further comprising a vehicle outside information detection part that detects a surrounding environment of the vehicle,
wherein the object recognition unit detects characteristics related to a spin or slip of the vehicle in consideration of the surrounding environment.

11. The video processing device according to claim 1, wherein
the object recognition unit detects, as the characteristics, characteristics related to illegal driving of the vehicle or surrounding vehicles thereof, and a violative act of a pedestrian.

12. The video processing device according to claim 11, wherein
the object recognition unit recognizes a traffic lane or a side strip from the video, and detects characteristics related to traveling of the vehicle deviating from the traffic lane.

13. The video processing device according to claim 11, wherein
the object recognition unit recognizes a traffic lane or a side strip and surrounding vehicles from the video, and detects characteristics related to traveling of the surrounding vehicles deviating from the traffic lane.

14. The video processing device according to claim 11, wherein
the object recognition unit obtains information associated with regulations prescribed for a traveling road on the basis of a result of object recognition of the video, and when a traveling state of the vehicle or a surrounding vehicle thereof does not agree with the regulations, detects characteristics related to illegal driving.

15. The video processing device according to claim 14, wherein
information associated with regulations prescribed for a traveling road is obtained further on the basis of map information.

16. The video processing device according to claim 11, wherein
the object recognition unit recognizes, from the video, at least one of a road traffic sign installed on the roadside, a road traffic sign drawn on a road surface, a stop line position drawn on a road, and a traffic light, and when at least one of violation of a road traffic sign, disregard of a stop line position, and disregard of a traffic light, of the vehicle or a surrounding vehicle thereof, is detected, detects characteristics related to illegal driving.

17. The video processing device according to claim 11, wherein
the object recognition unit subjects a stop line on a road to object recognition, and in a case where it is determined, from a relationship between a vehicle speed or acceleration of the vehicle or a surrounding vehicle thereof and a stop line position, that stopping is impossible, detects characteristics related to illegal driving of stop position disregard.

18. The video processing device according to claim 11, wherein
the object recognition unit subjects a red signal or yellow signal of a traffic light to object recognition, and in a case where it is determined, from a relationship between a vehicle speed or acceleration of the vehicle or a surrounding vehicle thereof and a position of the traffic light subjected to the object recognition, that stopping is impossible, detects characteristics related to illegal driving of traffic light disregard.

19. The video processing device according to claim 11, wherein
the object recognition unit subjects both a traveling state of a surrounding vehicle and lighting of a lamp to object recognition, and when the traveling state does not agree with the lighting of the lamp, detects characteristics related to violation related to nonperformance of signaling of the surrounding vehicle.

20. A video processing method comprising:
an object recognition step for, on the basis of a result of recognizing an object included in a video obtained by image-capturing an outside or an inside of a vehicle, detecting characteristics of a scene in which there is a possibility of leading to an accident; and
a control step for, according to detection of the characteristics, controlling processing of the video.
